(19) United States
(12) Patent Application Publication
(10) Pub. No.: US 2026/0039703 A1
(43) Pub. Date: Feb. 5, 2026

(54) COMMUNICATING A CONNECT PROTOCOL FOR A PROTOCOL DATA UNIT SESSION OR A PACKET DATA NETWORK CONNECTION

(71) Applicant: Lenovo (Singapore) Pte Ltd, Singapore (SG)

(72) Inventor: Roozbeh Atarius, La Jolla, CA (US)

(73) Assignee: Lenovo (Singapore) Pte Ltd, Singapore (SG)

(21) Appl. No.: 18/793,683

(22) Filed: Aug. 2, 2024

(51) Int. Cl. H04L 65/1069; H04L 5/00; H04L 67/141

(52) U.S. Cl. CPC H04L 65/1069; H04L 5/0053; H04L 67/141

(57) ABSTRACT

Various aspects of the present disclosure relate to communicating a connect protocol for a protocol data unit (PDU) session or a packet data network (PDN) connection. A user equipment (UE) transmits a request message to establish a PDU session or a PDN connection, where the request message includes an indication of a connect protocol for the PDU session or the PDN connection, and the indication is included in at least one of a standalone information element or a part of an information element. The UE receives a response message based at least in part on the request message, where the response includes one or more rules for the PDU session or the PDN connection.

### TECHNICAL FIELD

The present disclosure relates to wireless communications, and more specifically to communicating a connect protocol for a protocol data unit session or a packet data network connection.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication. The UE transmits a request message to establish a protocol data unit (PDU) session or a packet data network (PDN) connection, wherein the request message includes an indication of a connect protocol for the PDU session or the PDN connection, wherein the indication is included in at least one of a standalone information element or a part of an information element; and receives a response message based at least in part on the request message, wherein the response includes one or more rules for the PDU session or the PDN connection.

In some implementations of the method and apparatuses described herein, the connect protocol comprises: a user datagram protocol (UDP), an Internet protocol (IP), an ethernet protocol, or a transmission control protocol (TCP). Additionally or alternatively, the part of the information element comprises a capability information element, and wherein the capability information element comprises a fifth generation (5G) session management (5GSM) capability information element. Additionally or alternatively, the part of the information element comprises an access traffic steering, switching, splitting (ATSSS) request protocol configuration options (PCO) parameter container within an additional container, wherein the additional container is identified as an ATSSS request and is included within an extended PCO (ePCO) information element. Additionally or alternatively, the indication comprises at least one bit, and wherein a value of the at least one bit is indicative of whether the connect protocol is supported or preferred by the UE. Additionally or alternatively, a first value of the at least one bit is indicative of the connect protocol supported or preferred by the UE, and wherein a second value of the at least one bit is indicative of the connect protocol not supported or not preferred by the UE. Additionally or alternatively, the connect protocol comprises a UDP in response to no bit of the at least one bit indicating a connect protocol supported or preferred by the UE. Additionally or alternatively, the request message includes a data network name (DNN) or an access point name (APN), and wherein the connect protocol and at least one of the DNN or the APN are input for a steering functionality associated with multipath QUIC (MPQUIC). Additionally or alternatively, at least one user plane resource of a multiple access PDU (MA-PDU) session is established based at least in part on the PDU session or the PDN connection.

Some implementations of the method and apparatuses described herein may further include a processor for wireless communication. The processor transmits a request message to establish a PDU session or a PDN connection, wherein the request message includes an indication of a connect protocol for the PDU session or the PDN connection, wherein the indication is included in at least one of a standalone information element or a part of an information element; and receives a response message based at least in part on the request message, wherein the response includes one or more rules for the PDU session or the PDN connection.

In some implementations of the method and apparatuses described herein, the connect protocol comprises: a UDP, an IP, an ethernet protocol, or a TCP. Additionally or alternatively, the part of the information element comprises a capability information element, and wherein the capability information element comprises a 5GSM capability information element. Additionally or alternatively, the part of the information element comprises an ATSSS request PCO parameter container within an additional container, wherein the additional container is identified as an ATSSS request and is included within an ePCO information element. Additionally or alternatively, the indication comprises at least one bit, and wherein a value of the at least one bit is indicative of whether the connect protocol is supported or preferred by the processor. Additionally or alternatively, a first value of the at least one bit is indicative of the connect protocol supported or preferred by the processor, and wherein a second value of the at least one bit is indicative of the connect protocol not supported or not preferred by the processor. Additionally or alternatively, the request message includes a data DNN or an APN, and wherein the connect protocol and at least one of the DNN or the APN are input for a steering functionality associated with MPQUIC.

Some implementations of the method and apparatuses described herein may further include a network equipment for wireless communication. The network equipment receives, a request message to establish a PDU session or a PDN connection, wherein the request message includes an indication of a connect protocol for the PDU session or the PDN connection, wherein the indication is included in at least one of a standalone information element or a part of an information element; and transmits a response message based at least in part on the request message, wherein the response includes one or more rules for the PDU session or the PDN connection.

In some implementations of the method and apparatuses described herein, the connect protocol comprises: a UDP, an IP, an ethernet protocol, or a TCP. Additionally or alternatively, the request message includes a data DNN or an APN, and wherein the connect protocol and at least one of the DNN or the APN are input for a steering functionality associated with MPQUIC, and the network equipment to checks whether the DNN or APN can comply with the indicated connect protocol; and transmits the response message including the one or more rules in response to the DNN or APN being able to comply with the indicated connect protocol.

Some implementations of the method and apparatuses described herein may further include a method performed by a UE, the method comprising: transmitting a request message to establish a PDU session or a PDN connection, wherein the request message includes an indication of a connect protocol for the PDU session or the PDN connection, wherein the indication is included in at least one of a standalone information element or a part of the information element; and receiving a response message based at least in part on the request message, wherein the response includes one or more rules for the PDU session or the PDN connection.

### BRIEF DESCRIPTION OF THE DRAWINGS

FIG. 1 illustrates an example of a wireless communications system in accordance with aspects of the present disclosure.

FIG. 2 illustrates an example of a UDP datagram containing one QUIC packet in accordance with aspects of the present disclosure.

FIG. 3 illustrates an example of a hypertext transfer protocol (HTTP) data frame that is transported over QUIC as the part of stream data in accordance with aspects of the present disclosure.

FIG. 4 illustrates an example of UDP containing a QUIC packet with a DATAGRAM frame in accordance with aspects of the present disclosure.

FIG. 5 illustrates an example of a context identifier (ID) determining the semantic of a transmitted UDP in accordance with aspects of the present disclosure.

FIG. 6 illustrates an example of a user plane protocol stack when the MPQUIC functionality is applied in accordance with aspects of the present disclosure.

FIG. 7 illustrates an example of the semantic of IP packets proxying HTTP datagrams in accordance with aspects of the present disclosure.

FIG. 8 illustrates an example of the user plane protocol stack in accordance with aspects of the present disclosure.

FIG. 9 illustrates an example of the semantic layer 2 Ethernet frames proxying HTTP datagrams in accordance with aspects of the present disclosure.

FIGS. 10 and 11 illustrate examples of the user plane protocol stack in accordance with aspects of the present disclosure.

FIGS. 12 through 14 illustrate examples of a connect protocol information element as a type 1 information element in accordance with aspects of the present disclosure.

FIGS. 15 through 17 illustrate examples of a connect protocol information element as a type 4 information element in accordance with aspects of the present disclosure.

FIGS. 18 and 19 illustrate examples of connect protocol included in a 5GSM capability information element information in accordance with aspects of the present disclosure.

FIG. 20 illustrates an example of a connect protocol information element as a type 1 information element in accordance with aspects of the present disclosure.

FIG. 21 illustrates an example of MA PDU session establishment in accordance with aspects of the present disclosure.

FIGS. 22 through 25 illustrate examples of ATSSS request PCO parameter container contents in accordance with aspects of the present disclosure.

FIG. 26 illustrates an example of MA PDU session establishment in accordance with aspects of the present disclosure.

FIG. 27 illustrates an example of a UE in accordance with aspects of the present disclosure.

FIG. 28 illustrates an example of a processor in accordance with aspects of the present disclosure.

FIG. 29 illustrates an example of a network equipment (NE) in accordance with aspects of the present disclosure.

FIG. 30 illustrates a flowchart of a method performed by a UE in accordance with aspects of the present disclosure.

FIG. 31 illustrates a flowchart of a method performed by a NE in accordance with aspects of the present disclosure.

### DETAILED DESCRIPTION

MPQUIC functionality is a type of higher layer steering functionality that can use MPQUIC to enable steering, switching, and splitting of UDP traffic between the UE and the UPF using the ATSSS feature. ATSSS covers MPQUIC steering functionality proxying the UDP packets in the HTTP datagrams, described in Internet engineering task force (IETF) request for comments (RFC) 9298, by introducing transport modes Datagram mode 1 and Datagram mode 2. Release 19 of ATSSS in 3^{rd} Generation Partnership Project (3GPP) Technical Report (TR) 23.700-54 further describes how to implement an IP packet tunneled over QUIC, such as for a virtual private network (VPN) by MPQUIC steering functionality proxying the IP packets in the HTTP datagrams as described in IETF RFC 9484. Future releases of ATSSS may also implement the MPQUIC steering functionality proxying an Ethernet frame in the HTTP datagrams or the MPQUIC steering functionality proxying TCP in HTTP.

To proxy UDP, IP, Ethernet, or TCP in HTTP, the specific connect protocol (also referred to as connection protocol or connection type) is to be specified at the time of establishment of the MA PDU session user plane resource. However, no mechanism exists for the UE to specify the connect protocol supported or preferred by the UE. Using the techniques discussed herein, if the UE is establishing MA PDU session user plane resources (e.g., with the MPQUIC steering functionality) with any transport modes, the UE informs the network of the supported or preferred connect protocols (e.g., at least one of connect-udp (for the UDP connect protocol), connect-ip (for the IP connect protocol), connect-tcp (for the TCP protocol), or connect-ethernet (for the ethernet protocol)) at the time of establishing the MA PDU session.

Using the techniques discussed herein, a UE transmits a request message (e.g., part of the non-access stratum (NAS) protocol) to establish a PDU session or a PDN connection. The request message includes an indication of a connect protocol for the PDU session or the PDN connection, and this indication is included in at least one of a standalone information element or a part of an information element. The connect protocol can be, for example, at least one of UDP, an IP, an ethernet protocol, or a TCP. The request message informs the session and mobility management function (SMF) or SMF and PDN gateway control plane function (SMF+PGW-C) of the UE's capability, desire, and or preferred connect protocol that is to be used when the UE attempts to establish an MA PDU session user plane resource. The UE receives a response message based at least in part on the request message, and the response includes one or more rules for the PDU session or the PDN connection. These rules, for example, describe how to control the traffic steering, switching and splitting in the uplink direction, such as how the UE is expected to utilize the access networks (e.g., 3GPP and/or non-3GPP networks) available to the UE. The response message is received from, for example, a NE (e.g., a base station), which passes the response message (or information in the response message) from the core network (e.g., an AMF).

Accordingly, the techniques discussed herein describe how the UE can specify the connect protocol supported or preferred by the UE, allowing an MA PDU session user plane resource to be established based on the connect protocol supported or preferred by the UE.

Aspects of the present disclosure are described in the context of a wireless communications system.

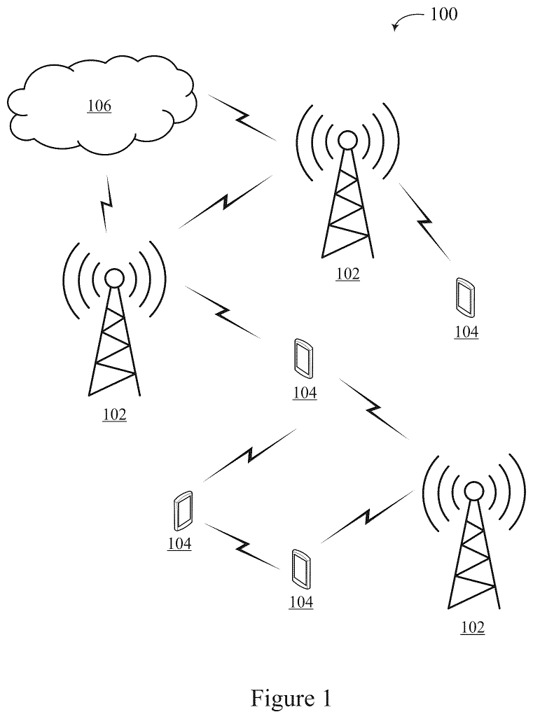

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (SGW), a packet data network (PDN) gateway (P-GW), or a user plane function (UPF)). In some implementations, the control plane entity may manage NAS functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-52.6 GHZ), FR3 (7.125 GHZ-24.25 GHZ), FR4 (52.6 GHz-114.25 GHZ), FR4a or FR4-1 (52.6 GHZ-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The techniques discussed herein describe a UE 104 transmitting a request message to establish a PDU session or a PDN connection. The request message is transmitted to, for example, a NE 102 (e.g., a base station), which passes the request message (or information in the request message) to the CN 106 (e.g., an AMF). The request message includes an indication of a connect protocol for the PDU session or the PDN connection, and this indication is included in at least one of an information element or a container. The connect protocol can be, for example, at least one of type UDP, type IP, type ethernet, or type TCP. The connect protocol can be specified, for example, in a new information element, part of an existing information element, or added in an existing container for extended protocol configuration options. The UE 104 receives a response message based at least in part on the request message, and the response includes one or more rules for the PDU session or the PDN connection. These rules describe the traffic steering, switching and splitting in the uplink direction, such as how the UE 104 is expected to utilize the access networks (e.g., 3GPP and/or non-3GPP) available to the UE 104. The response message is received from, for example, a NE 102 (e.g., a base station), which passed the response message (or information in the response message) the NE 102 received from the CN 106 (e.g., an AMF or an MME). At least one user plane resource of a multiple access PDU (MA-PDU) session is established based at least in part on the PDU session or the PDN connection.

Reference is made herein to receiving or transmitting data, information, messages, and so forth. It is to be appreciated that other terms may be used interchangeably with receiving or transmitting, such as communicating, outputting, forwarding, retrieving, obtaining, and so forth.

A steering functionality referred to as multipath QUIC (MPQUIC) functionality can be defined to include transport modes of stream mode, datagram mode 1, and/or datagram mode 2 for an MA PDU session, where simultaneous communication can occur over multiple paths such as 3GPP access or non-3GPP access.

MPQUIC steering functionality is based on QUIC and is a UDP-based multiplexed and secure transport protocol. Peers communicate in QUIC by exchanging QUIC packets, which usually contain frames with control information or data. QUIC packets are carried in UDP datagrams to better facilitate deployment in existing systems and networks. One or more QUIC packets can be encapsulated in a single UDP datagram.

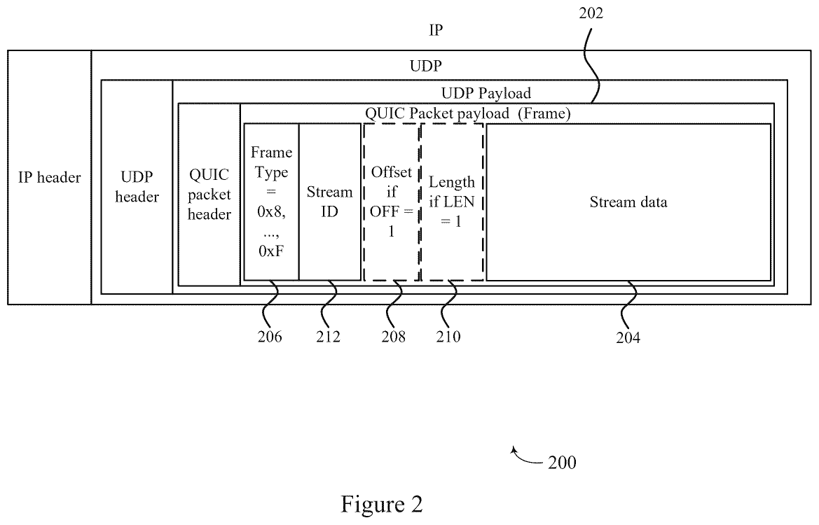

FIG. 2 illustrates an example 200 of a UDP datagram containing one QUIC packet in accordance with aspects of the present disclosure. The QUIC packet 202 in the example 200 includes a STREAM frame with stream data 204.

Stream mode uses the STREAM frame to carry stream data with the type field 206 as 0b00001XXX (0x08 thru 0x0F). The three least significant bits determine the fields that are in the frame. An OFF bit (0x04) is to indicate that there is an Offset field 208 present. A value of “1” indicates that there is an offset field while a value of “O” indicates the stream data starts at offset 0. A LEN bit (0x02) is to indicate that there is a length field 210 present. A value of “1” indicates that there is a length field present while a value of “O” indicates that the stream data field extends to the end of the QUIC packet 202 (the STREAM frame). A FIN bit (0x01) is to indicate the end of the stream. A value of “1” indicates that the frame marks the end of the stream, otherwise it is set to a value “0”. A stream ID field 212 indicates an identifier of the stream.

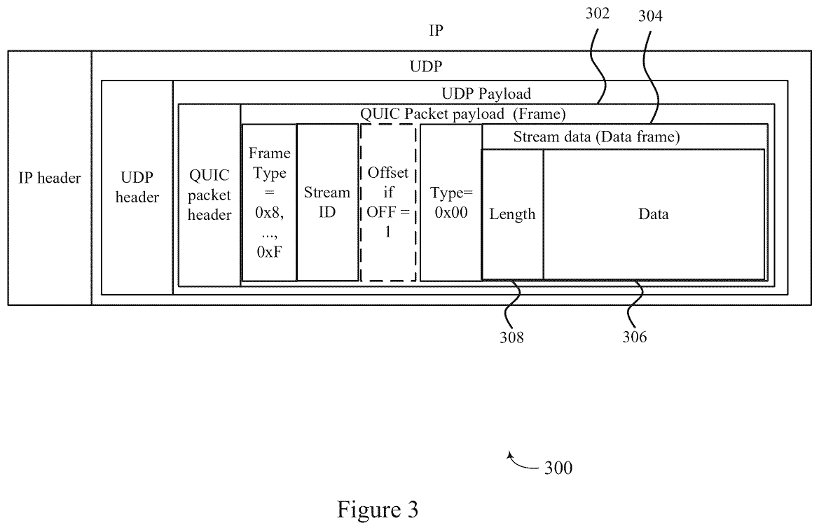

FIG. 3 illustrates an example 300 of an HTTP data frame that is transported over QUIC as the part of stream data in accordance with aspects of the present disclosure. IETF RFC 9114 describes the mapping of HTTP semantics over QUIC, where the HTTP data frame is transported over QUIC as the part of stream data. The QUIC packet 302 in the example 300 includes a STREAM frame 304 that includes an HTTP data frame with data 306. In the example 300, since the STREAM frame 304 includes length 308 for the data 306, there is no need to have length in the stream frame, thus, LEN bit (0x02) is set to value “0”.

In addition to the reliable STREAM frame in example 300, IETF RFC 9221 describes a DATAGRAM frame extension for QUIC protocol to define unreliable frames for transmission. This is due to the reasoning that some applications or services expect fast transmission of data.

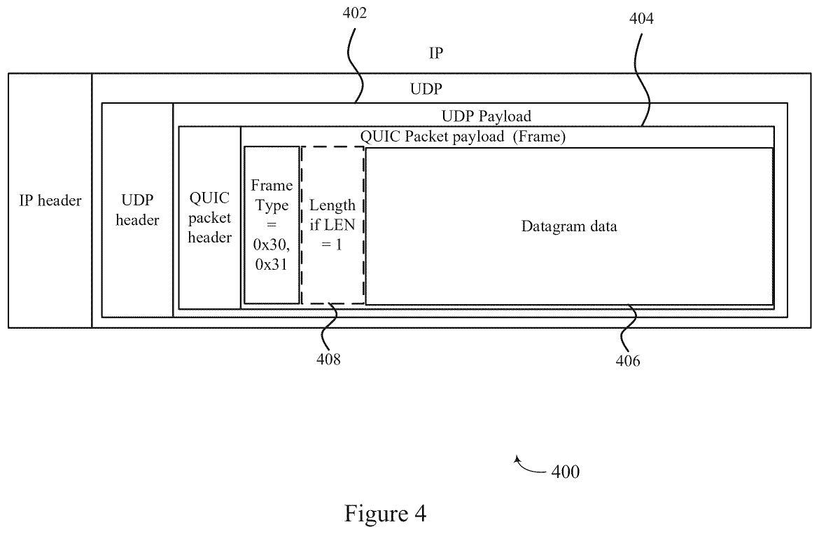

FIG. 4 illustrates an example 400 of UDP containing a QUIC packet with a DATAGRAM frame in accordance with aspects of the present disclosure. The example 400 illustrates a UDP datagram 402 containing one QUIC packet 404 with a datagram frame 406.

The datagram frame 406 is to carry datagram data with the type field as 0b0011000X (0x30 or 0x31). The least significant bit determines the field that is in the frame. A LEN bit (0x01) is to indicate that there is a length field 408 present. A value of “1” indicates that there is a length field 408 while a value of “O” indicates that the datagram data field extends to the end of the QUIC packet 404.

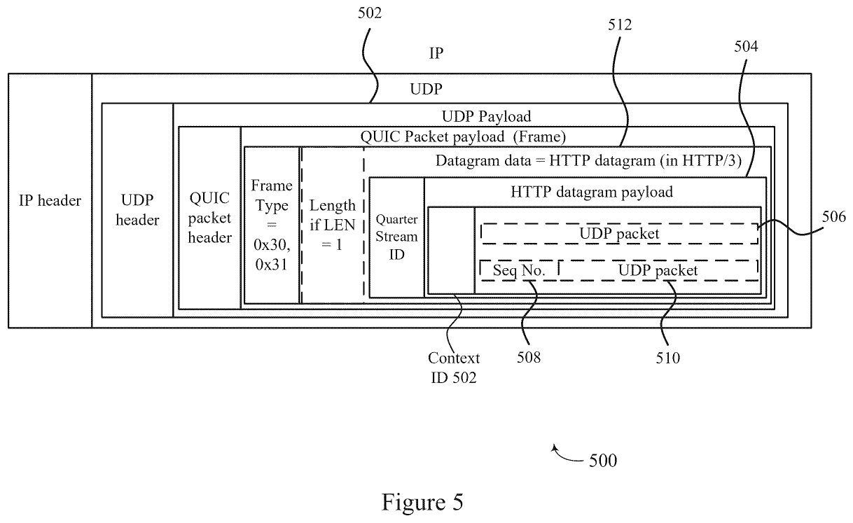

FIG. 5 illustrates an example 500 of a context ID determining the semantic of a transmitted UDP in accordance with aspects of the present disclosure. IETF RFC 9297 describes the unreliable transmission of HTTP datagrams in HTTP/3. IETF RFC 9298 describes how to proxy UDP in HTTP datagram for the purpose of HTTP client tunnels for UDP communication through an HTTP server acting as a UDP proxy. For the negotiation of such a tunnelling for UDP over HTTP, IETF RFC 9298 defines the “connect-udp” HTTP upgrade token. IETF RFC 9298 defines also an identifier, context ID, whose value determines the semantic of how the UDP proxying in the HTTP datagram is done. Context ID with a value “0” is defined in IETF RFC 9298 that one UDP is proxying in the HTTP datagram. This semantic is defined as datagram mode 2 according to 3GPP TS 24.913. Furthermore, 3GPP TS 24.913 also defines datagram mode 1 where a new semantic of the payload contains a sequence number in addition to one UDP packet. The value for the context ID is other than zero for datagram mode 1.

The example 500 shows due to the value of the context ID 502, the HTTP datagram payload 504 contains either one UDP packet 506 or a sequence number 508 and one UDP packet 510. The sequence number 508 is used to determine the order of transmitted UDP packets encapsulated within the HTTP datagram 512 in HTTP/3.

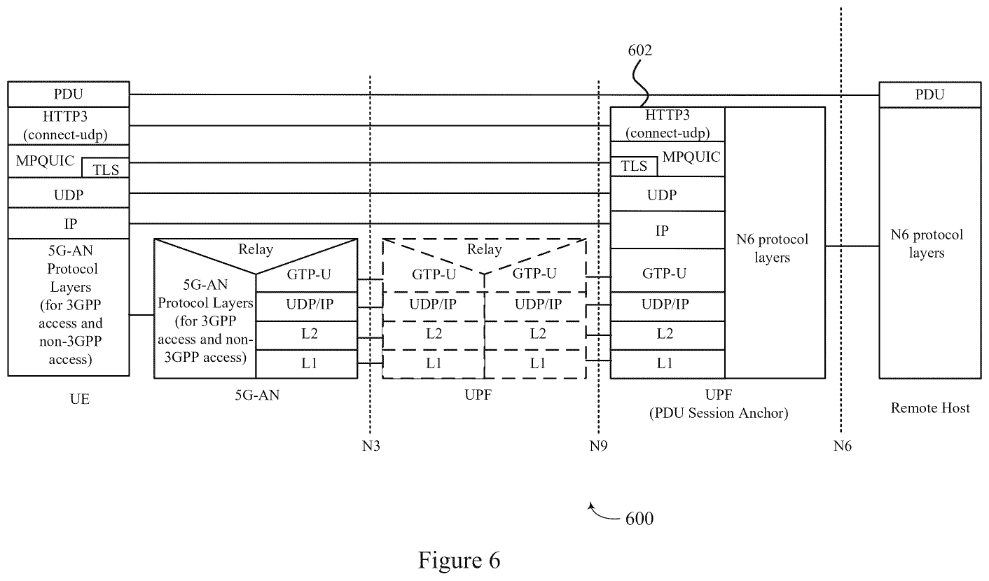

FIG. 6 illustrates an example 600 of a user plane protocol stack when the MPQUIC functionality is applied in accordance with aspects of the present disclosure. The example 600, also discussed in 3GPP TR 23.700-54, shows the user plane protocol stack when the MPQUIC steering functionality using UDP proxying request which includes the value “connect-udp” in the Upgrade header field 602, is used for MA PDU session. The example 600 shows within the 3GPP network between the UE and the UPF, the MPQUIC steering functionality.

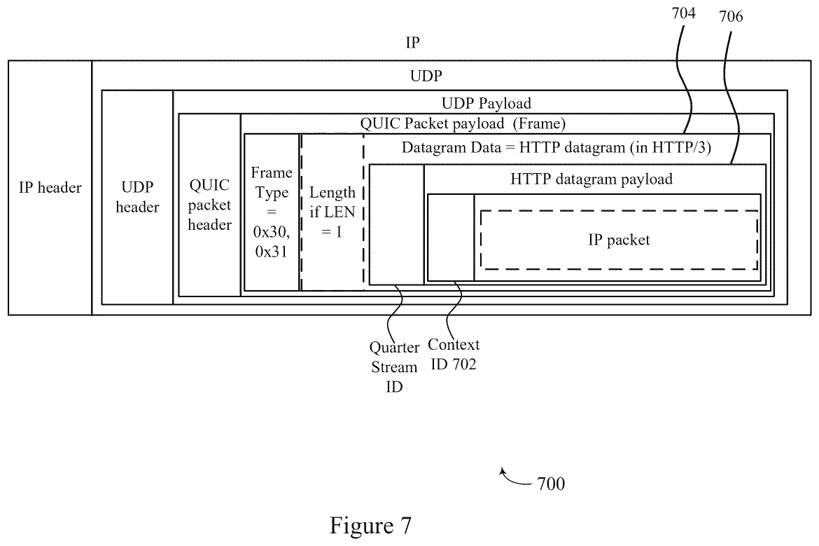

FIG. 7 illustrates an example 700 of the semantic of IP packets proxying HTTP datagrams in accordance with aspects of the present disclosure. IETF RFC 9484 defines proxying IP packets in HTTP datagrams for tunnelling IP through an HTTP server acting as an IP-specific proxy over HTTP. This can be used for use cases, such as remote access VPN, site-to-site VPN, secure point-to-point communication, or general-purpose packet tunnelling. Similar to IETF RFC 9298, IETF RFC 9484 uses the context ID 702 to identify the semantic of the IP proxying in the HTTP datagram. Context ID 702 with a value of “0” is defined in IETF RFC 9484 that an IP packet can be proxying in the HTTP datagram 704, as illustrated in the example 700. The context ID in the example 700 is set to a value of “0” so the HTTP datagram payload 706 can contain one IP packet.

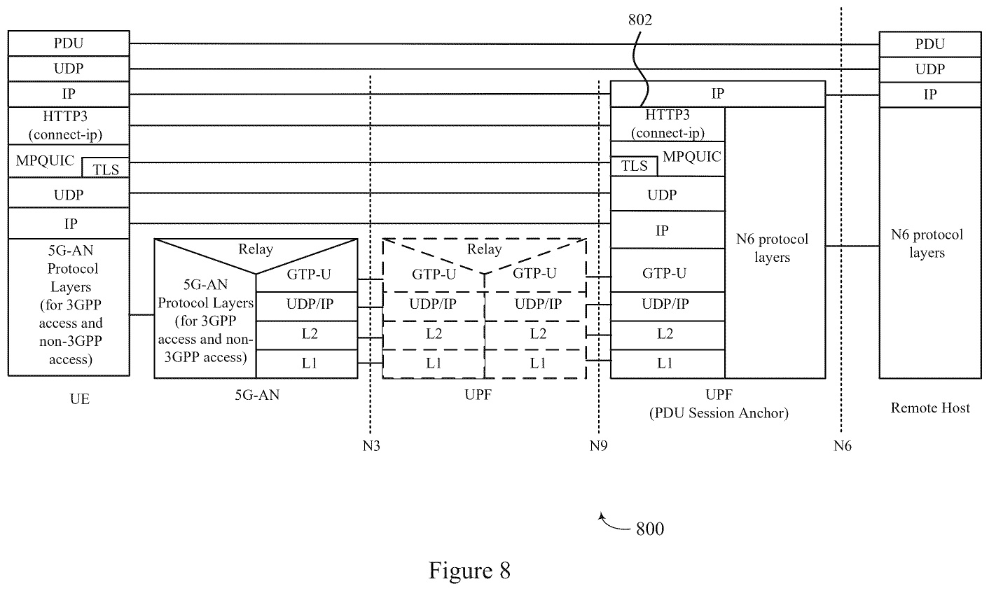

FIG. 8 illustrates an example 800 of the user plane protocol stack in accordance with aspects of the present disclosure. The example 800, also discussed in 3GPP TR 23.700-54 shows the user plane protocol stack when the MPQUIC steering functionality using IP proxying request which includes the value “connect-ip” in the Upgrade header field 802, is used for MA PDU session.

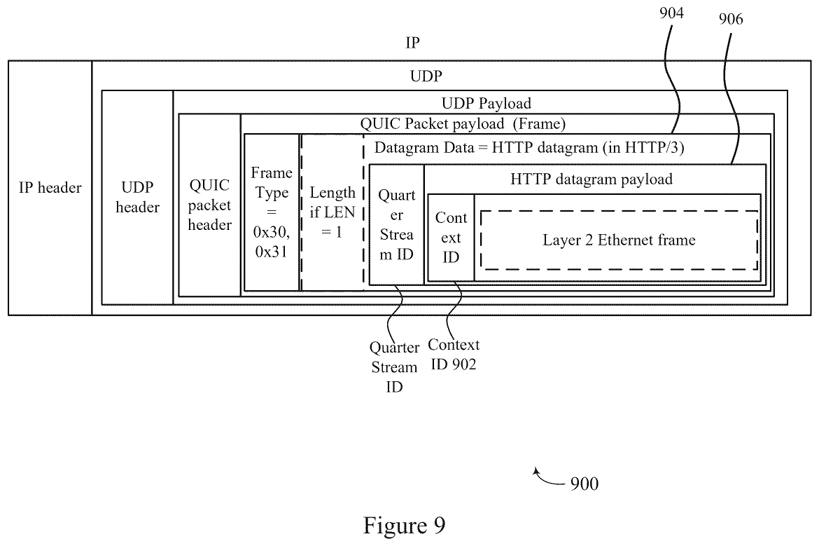

FIG. 9 illustrates an example 900 of the semantic layer 2 Ethernet frames proxying HTTP datagrams in accordance with aspects of the present disclosure. The draft-ietf-masque-connect-ethernet defines proxying full layer 2 Ethernet frames (from the MAC destination field until the last byte of the frame check sequence field) in HTTP datagrams for tunnelling layer 2 Ethernet frames through an HTTP server acting as an Ethernet-specific proxy over HTTP. This feature enables the bridging of Ethernet broadcast domains which can be used for use cases, such as remote access layer 2 VPN (L2VPN) and site-to-site L2VPN. Similar to the UDP and IP tunnelling, the draft-ietf-masque-connect-ethernet uses the context ID 902 to identify the semantic of the Ethernet proxying in the HTTP datagram. Context ID 902 with a value “0” is defined in draft-ietf-masque-connect-ethernet that an Ethernet frame can be proxying in the HTTP datagram 904. The context ID 902 in the example 900 is set to a value of “O” so the HTTP datagram payload 906 can contain one layer 2 Ethernet frame.

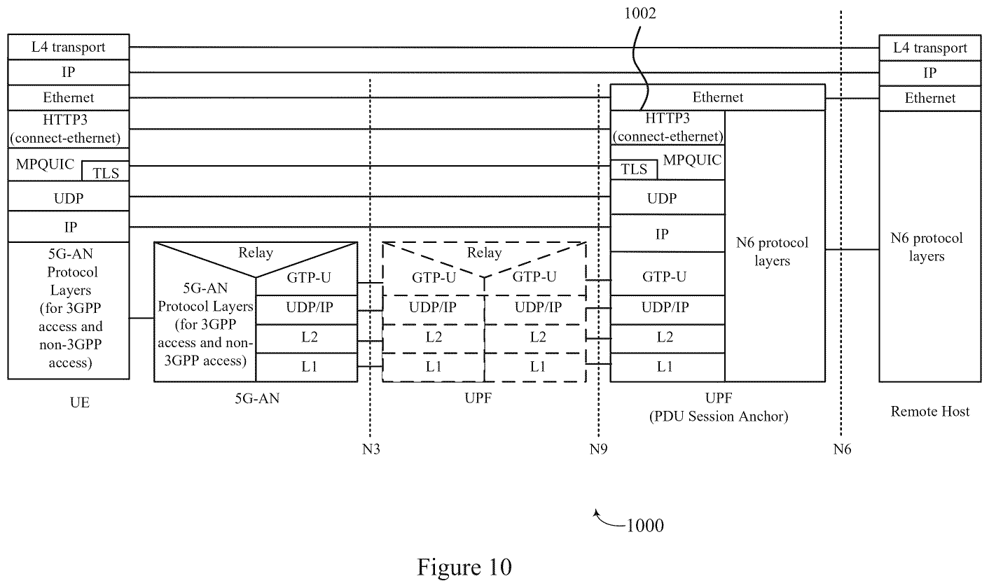

FIG. 10 illustrates an example 1000 of the user plane protocol stack in accordance with aspects of the present disclosure. The example 1000, also discussed in 3GPP TR 23.700-54 shows the user plane protocol stack when the MPQUIC steering functionality using Ethernet proxying request which includes the value “connect-ethernet” in the Upgrade header field 1002, is used for MA PDU session.

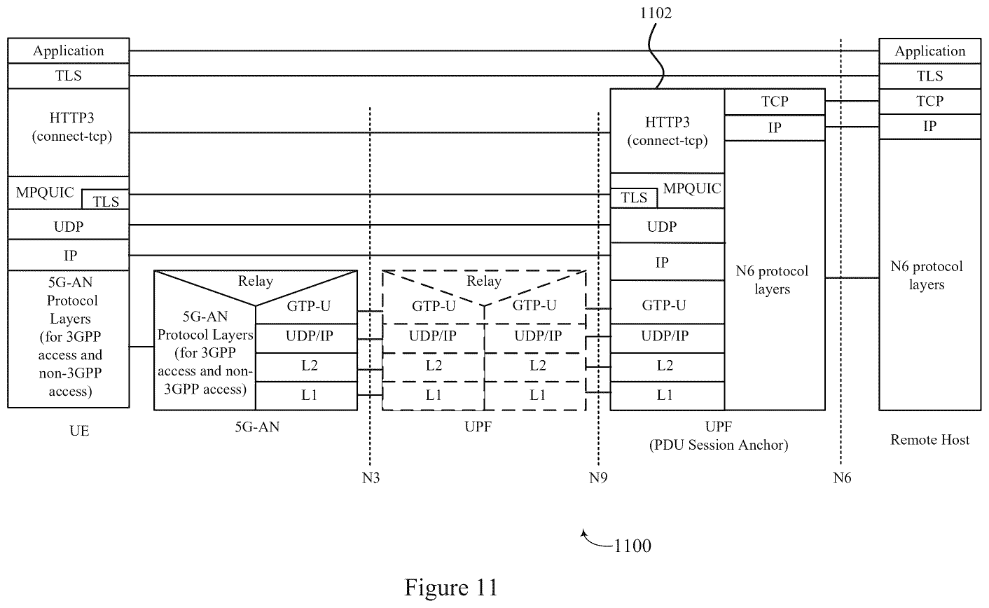

FIG. 11 illustrates an example 1100 of the user plane protocol stack in accordance with aspects of the present disclosure. The example 1100, also discussed in draft-ietf-httpbis-connect-tcp describes an alternative mechanism for proxying TCP in HTTP than the CONNECT method. The example 1100, also discussed in 3GPP TR 23.700-54, shows the user plane protocol stack when the MPQUIC steering functionality using TCP proxying request which includes the value “connect-tcp” in the Upgrade header 1102 field, is used for MA PDU session.

To establish a PDU session as the user plane resource of an MA PDU session, the UE constructs the uplink (UL) NAS TRANSPORT message that can include request type information element indicating the value for an MA PDU request. Additionally or alternatively, the UL NAS TRANSPORT message includes a DNN information element with the configuration that allows the desired steering functionality and the supported or preferred connect protocol. Additionally or alternatively, the UL NAS TRANSPORT message includes a connect protocol information element to identify the type of connect (e.g., one or more of TCP, Ethernet, IP, or UDP) for the desired steering functionality. Additionally or alternatively, the UL NAS TRANSPORT message includes a payload container information element to 5GSM message which in this example is the PDU SESSION ESTABLISHMENT REQUEST message with information element for the MA PDU session including: 1) the 5GSM capability information element, which includes the capability for the ATSSS steering functionalities, and may include the supported connect protocols; and 2), if not included as a part of the 5GSM capability information element, the connect protocol information element as a standalone information element. It should be noted that the supported or preferred connect protocol may be included in both the UL NAS TRANSPORT message and the 5GSM message which is the PDU SESSION ESTABLISHMENT REQUEST message in this example.

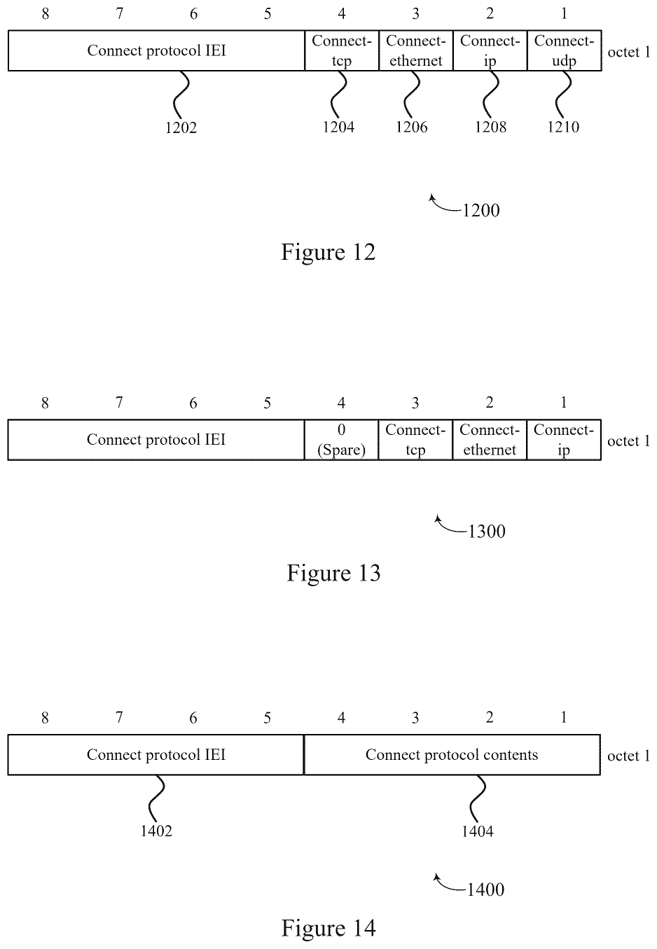

In one or more implementations, the connect protocol information element is implemented as a standalone information element. A standalone information element refers to an information element that exists on its own rather than being part of another information element. A standalone information element may be an information element exclusively for indicating a connect protocol for a PDU session and/or a PDN connection. Specifically, the information element may contain a single information element field (e.g., element) that indicates the connect protocol for the PDU session and/or the PDN connection. In other words, the standalone information element does not carry any additional information beyond the connect protocol and/or information/parameters pertaining to the connect protocol. The standalone information element can be, for example, a type 1 information element or a type 4 information element. Examples of standalone information elements are illustrated in FIGS. 12-17 below.

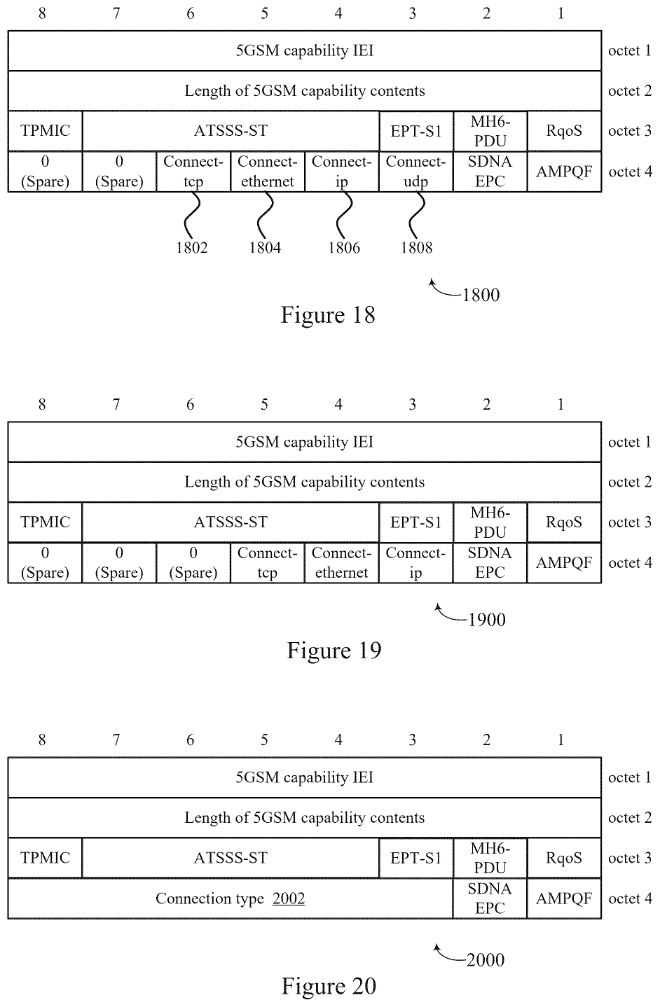

Alternatively, an information element may include a set of information element fields, with at least one information element field indicating the connect protocol for the PDU session and/or the PDN connection. For example, an indication of the connect protocol may be part of the information element. As such, the IE carries additional information (e.g., a transfer of port management information containers (TPMIC) bit indicating whether transfer of port management information containers is supported, an Ethernet PDN type in S1 (EPT-S1) bit indicating whether Ethernet PDN type in S1 mode is supported, an access performance measurements per quality of service (AMPQF) bit indicating whether access performance measurements per quality of service flow are supported, a reflective quality of service (RqoS) bit indicating whether reflective quality of service is supported, supported ATSSS steering functionalities, and so forth) beyond the connect protocol. Examples of such information elements are illustrated in FIGS. 18-20 and 22-25 below

FIG. 12 illustrates an example 1200 of a connect protocol information element as a type 1 information element in accordance with aspects of the present disclosure. In the example 1200, the connect protocol information element identifier (IEI) 1202 is a hexadecimal digit to identify the connect protocol information element. The bit which represents the connection type is set to the value “1” to identify that type of connection that is supported or preferred by the UE. For example, the connect-tcp bit 1204 is set to the value of “1” if TCP is the supported or preferred connection type, the connect-ethernet bit 1206 is set to the value of “1” if Ethernet is the supported or preferred connection type, the connect-ip bit 1208 is set to the value of “1” if IP is the supported or preferred connection type, and the connect-UDP bit 1210 is set to the value of “1” if UDP is the supported or preferred connection type. If all the bits are set to the value “0”, it means that the supported connection type is connect-udp. Thus, the connect protocol information element is backward compatible with release 18 of ATSSS where the connection type was connect-udp as default.

FIG. 13 illustrates an example 1300 of a connect protocol information element as a type 1 information element in accordance with aspects of the present disclosure. The information element in the example 1300 is similar to the information element in the example 1200, except that the example 1300 does not include a connect-udp bit. Since in release 18 of 3GPP the ATSSS feature supports connect-udp as the default connection type for MPQUIC steering functionality, it may be assumed that no indication is needed if the connect-udp is preferred (e.g., required) and/or supported by the UE during the MA PDU session. Thus, the connect protocol information element shown in example 1300 contains only the indicator for connect-ip, connect-ethernet, and/or connect-tcp. Thus, if the connect protocol is not included for the procedure of MA PDU session establishment or modification procedures, it is assumed that connect-udp is preferred (e.g., required) or supported by the UE for the MPQUIC steering functionality. When using the connect protocol information element of example 1300, it is assumed that the UE supports connect-udp by default if the UE wants to list more than one connection type.

FIG. 14 illustrates an example 1400 of a connect protocol information element as a type 1 information element in accordance with aspects of the present disclosure. In the example 1400, the connect protocol IEI 1402 is a hexadecimal digit to identify the connect protocol information element. Multiple bits (up to all 4 bits) of the control protocol contents 1404 can be used to identify the connection type. For example, the preferred or supported connection type for the MPQUIC steering functionality of the MA PDU session can be identified as: 0 . . . 00 for connect-UDP, 0 . . . 01 for connect-ip, 0 . . . 10 for connect-ethernet, and 0 . . . 11 for connect-tcp. This configuration for the control protocol contents 1404 can be expanded if the UE lists more than one supported connection type.

For example, if there are 4 bits used to identify the connection type, the connection type can be identified as 0000 for connect-UDP, 0001 for connect-ip, 0010 for connect-ethernet, and 0011 for connect-TCP. By way of another example, if there are 4 bits used to identify the connection type, the connection type can be identified as 0000 for connect-UDP, 0001 for connect-ip, 0010 for connect-ethernet, 0011 for connect-tcp, 0100 for connect-udp and connect-ip, 0101 for connect-udp and connect-ethernet, 0110 for connect-udp and connect-tcp, 0111 for connect-ip and connect-ethernet, 1000 for connect-ip and connect-tcp, 1001 for connect-ethernet and connect-tcp, 0111 for connect-ip and connect-ethernet, 1000 for connect-ip and connect-tcp, 1001 for connect-ethernet and connect-tcp, 1010 for connect-udp, connect-ip, and connect-ethernet, 1011 for connect-udp, connect-ip, and connect-tcp, 1100 for connect-udp, connect-ethernet, and connect-tcp, 1110 for connect-ip, connect-ethernet, and connect-TCP, and 1111 for connect-ip, connect-udp, connect-ethernet, and connect-tcp.

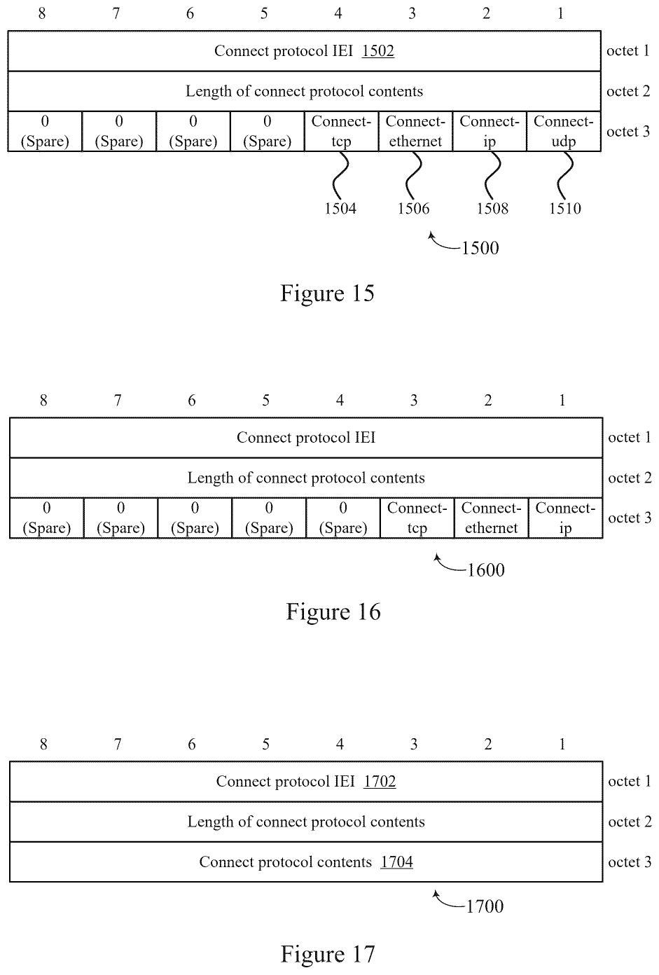

FIG. 15 illustrates an example 1500 of a connect protocol information element as a type 4 information element in accordance with aspects of the present disclosure. Using a type 4 information element can, for example, support more connection types than a type 1 information element.

In the example 1500, the connect protocol IEI 1502 is a hexadecimal digit to identify the connect protocol information element. The connect protocol IEI 1502 is two hexadecimal digits to identify the connect protocol information element and spare values are for future connection types. The bit which represents the connection type is set to the value “1” to identify that type of connection is supported or preferred by the UE. For example, the connect-tcp bit 1504 is set to the value of “1” if TCP is the supported or preferred connection type, the connect-ethernet bit 1506 is set to the value of “1” if Ethernet is the supported or preferred connection type, the connect-ip bit 1508 is set to the value of “1” if IP is the supported or preferred connection type, and the connect-UDP bit 1510 is set to the value of “1” if UDP is the supported or preferred connection type. If all the bits for the connection types are set to the value “0”, it means that the supported connection type is connect-udp. Thus, the connect protocol information element is backward compatible with release 18 of ATSSS where the connection type was connect-udp as default.

FIG. 16 illustrates an example 1600 of a connect protocol information element as a type 4 information element in accordance with aspects of the present disclosure. The information element in the example 1600 is similar to the information element in the example 1500, except that the information element in the example 1600 does not include a connect-udp bit. Since in release 18 of 3GPP the ATSSS feature supports connect-udp as the default connection type for MPQUIC steering functionality, it may be assumed that no indication is needed if the connect-udp is preferred (e.g., required) and/or supported by the UE during the MA PDU session. Thus, the connect protocol information element in example 1600 contains only the indicator for connect-ip, connect-ethernet, and/or connect-tcp. Thus, if the connect protocol is not included for the procedure of MA PDU session establishment or modification procedures, it is assumed that connect-udp is preferred (e.g., required) or supported for the MPQUIC steering functionality. When using the connect protocol information element of example 1600, it is assumed that the UE supports connect-udp by default if the UE wants to list more than one connection type.

FIG. 17 illustrates an example 1700 of a connect protocol information element as a type 4 information element in accordance with aspects of the present disclosure. In the example 1700, the connect protocol IEI 1702 is a hexadecimal digit to identify the connect protocol information element. Multiple bits (up to all 8 bits) of the control protocol contents 1704 can be used to identify the connection type.

For example, the preferred or supported connection type for the MPQUIC steering functionality of the MA PDU session can be identified as: 0 . . . 00 for connect-UDP, 0 . . . 01 for connect-ip, 0 . . . 10 for connect-ethernet, and 0 . . . 11 for connect-tcp. This configuration for the control protocol contents 1704 can be expanded if the UE lists more than one supported connection type.

For example, if there are 4 bits used to identify the connection type, the connection type can be identified as 0000 for connect-UDP, 0001 for connect-ip, 0010 for connect-ethernet, and 0011 for connect-TCP. By way of another example, if there are 4 bits used to identify the connection type, the connection type can be identified as 0000 for connect-UDP, 0001 for connect-ip, 0010 for connect-ethernet, 0011 for connect-tcp, 0100 for connect-udp and connect-ip, 0101 for connect-udp and connect-ethernet, 0110 for connect-udp and connect-tcp, 0111 for connect-ip and connect-ethernet, 1000 for connect-ip and connect-tcp, 1001 for connect-ethernet and connect-tcp, 0111 for connect-ip and connect-ethernet, 1000 for connect-ip and connect-tcp, 1001 for connect-ethernet and connect-tcp, 1010 for connect-udp, connect-ip, and connect-ethernet, 1011 for connect-udp, connect-ip, and connect-tcp, 1100 for connect-udp, connect-ethernet, and connect-tcp, 1110 for connect-ip, connect-ethernet, and connect-TCP, and 1111 for connect-ip, connect-udp, connect-ethernet, and connect-tcp.

In one or more implementations, the connect protocol information element is implemented as part of another information element, such as a 5GSM capability information element as defined in 3GPP TS 24.501 clause 9.11.4.1.

FIG. 18 illustrates an example 1800 of connect protocol included in a 5GSM capability information element information in accordance with aspects of the present disclosure. In the example 1800, the bits representing the connection types which are connect-udp, connect-ip, connect-ethernet, and connect-ethernet are set to the value “1” to indicate the preferred (e.g., required) or supported connection type for the MPQUIC steering functionality. For example, the connect-tcp bit 1802 is set to the value of “1” if TCP is the supported or preferred connection type, the connect-ethernet bit 1804 is set to the value of “1” if Ethernet is the supported or preferred connection type, the connect-ip bit 1806 is set to the value of “1” if IP is the supported or preferred connection type, and the connect-UDP bit 1808 is set to the value of “1” if UDP is the supported or preferred connection type. If all the bits are set to the value “0”, it means that the supported connection type is connect-udp. If no connection type is included in the 5GSM capability information element (e.g., bits 1802-1808 are set to the value “0”), the MA PDU session with the MPQUIC steering functionality uses the connect-udp type of connection.

FIG. 19 illustrates an example 1900 of connect protocol included in a 5GSM capability information element information in accordance with aspects of the present disclosure. The example 1900 is similar to the example 1800, except that the example 1900 does not include a connect-udp bit. Since in release 18 of 3GPP the ATSSS feature supports connect-udp as the default for MPQUIC steering functionality, it may be assumed that no indication is needed if the connect-udp is preferred (e.g., required) and/or supported by the UE during the MA PDU session. If no connection type is included in the 5GSM capability information element (e.g., the connect-tcp, connect-ethernet, and connect-ip bits are set to the value “0”), the MA PDU session with the MPQUIC steering functionality uses the connect-udp type of the connection. Otherwise, if a connection type is set to the value “1”, the MA PDU session with the MPQUIC steering functionality uses the connection type corresponding to the connection type bit set to value “1”.

FIG. 20 illustrates an example 2000 of a connect protocol information element as a type 1 information element in accordance with aspects of the present disclosure. Multiple bits (up to all 6 bits) of the connection type 2002 contents can be used to identify the connection type. For example, the preferred or supported connection type for the MPQUIC steering functionality of the MA PDU session can be identified as: 0 . . . 00 for connect-UDP, 0 . . . 01 for connect-ip, 0 . . . 10 for connect-ethernet, and 0 . . . 11 for connect-tcp.

For example, if there are 4 bits used to identify the connection type, the connection type can be identified as 0000 for connect-UDP, 0001 for connect-ip, 0010 for connect-ethernet, and 0011 for connect-TCP. By way of another example, if there are 4 bits used to identify the connection type, the connection type can be identified as 0000 for connect-UDP, 0001 for connect-ip, 0010 for connect-ethernet, 0011 for connect-tcp, 0100 for connect-udp and connect-ip, 0101 for connect-udp and connect-ethernet, 0110 for connect-udp and connect-tcp, 0111 for connect-ip and connect-ethernet, 1000 for connect-ip and connect-tcp, 1001 for connect-ethernet and connect-tcp, 0111 for connect-ip and connect-ethernet, 1000 for connect-ip and connect-tcp, 1001 for connect-ethernet and connect-tcp, 1010 for connect-udp, connect-ip, and connect-ethernet, 1011 for connect-udp, connect-ip, and connect-tcp, 1100 for connect-udp, connect-ethernet, and connect-tcp, 1110 for connect-ip, connect-ethernet, and connect-TCP, and 1111 for connect-ip, connect-udp, connect-ethernet, and connect-tcp.

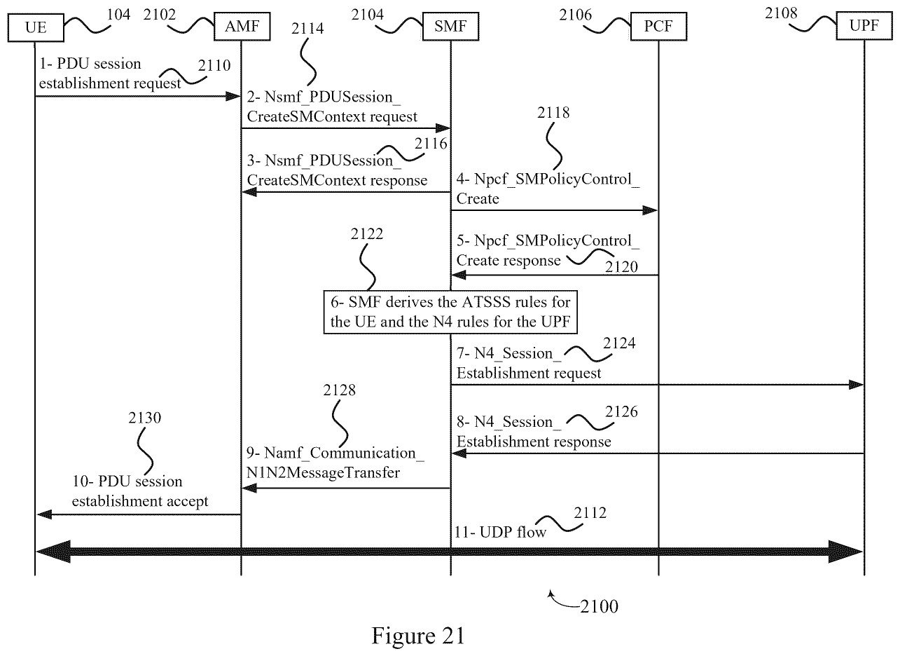

FIG. 21 illustrates an example 2100 of MA PDU session establishment in accordance with aspects of the present disclosure. FIG. 21 illustrates UE-requested MA PDU session establishment, with the assumption that the UE is already registered to the network. The example 2100 illustrates a UE 104, an access and mobility management function (AMF) 2102, a SMF 2104, a policy control function (PCF) 2106, and a user plane function (UPF) 2108. The AMF, SMF, PCF, and UPF are functions implemented by the wireless communications system 100, such as in the CN 106. The UE 104 communicates (e.g., transmits, sends) data, information, requests, etc. to a NE 102 (e.g., a base station), which communicates (e.g., transmits, sends) the data, information, requests, etc. to the appropriate function in the CN 106. Similarly, a function in the CN 106 communicates (e.g., transmits, sends) data, information, requests, etc. to a NE 102 (e.g., a base station), which communicates (e.g., transmits, sends) the data, information, requests, etc. to the UE 104.

At 2110, the UE 104 initiates (e.g., communicates, transmits, sends) a request message (e.g., a NAS message) to the AMF 2102. The request message is, for example, a PDU session establishment request. The UE 104 initiates the UE-requested MA PDU session establishment procedure by including several information elements within the NAS message for the MA PDU session establishment procedure including those which are used for the MA PDU session and depending on whether the connection information for the MPQUIC is defined as a standalone information element or part of another information element. Connect protocol information can be included in the request message using any of the information elements discussed above. The session establishment request at 2110 notifies the CN 106 (e.g., the AMF 2102) of the UE's desire to establish a MA PDU session (e.g., UDP flow 2112).

At 2114, the AMF 2102 determines an SMF 2104 to create a session management (SM) context based on the request message received from the UE 104. Upon determining the SMF 2104, the AMF 2102 constructs and communicates (e.g., transmits, sends) to the SMF 2104 a request to generate an SM context. The request to generate the SM context is, for example, an Nsmf_PDUSession_CreateSMContext request with information elements to create an SM context. The request to generate the SM context provides the SMF 2104 with the appropriate data, information, etc. to establish a SM context for the requested MA PDU session.

At 2116, an SM context is created. Upon creating the SM context, the SMF 2104 informs the AMF 2102 of the SM context ID for the created SM context. For example, the SMF 2104 communicates (e.g., transmits, sends) a Nsmf_PDUSession_CreateSMContext response to provide the SM context ID. The SM context ID provides addressing information allocated by the SMF 2104 (e.g., to be used for service operations towards the SMF 2104 for the requested MA PDU session.

At 2118, the SMF 2104 requests policy information for the requested MA PDU session. For example, the SMF 2104 requests the PCF 2106 to establish an SM Policy Association by transmitting the information about the PDU session by communicating (e.g., transmitting, sending), an Npcf_SMPolicyControl_Create. This provides the PCF 2106 with the appropriate data, information, etc. to determine the appropriate policy for the requested MA PDU session.

At 2120, the PCF 2106 communicates (e.g., transmits, sends) a response to the SMF 2104. For example, the PCF 2106 provides to the SMF 2104 the SMF policy information as policy and charging control (PCC) rules via Npcf_SMPolicyControl_Create response. The PCC rules include MPQUIC steering functionality, transport mode, and connection type (connect-udp, connect-ip, connect-ethernet and/or connect-tcp) and parameters associated with the connection type. This notifies the SMF 2104 of the appropriate policy to apply for the requested MA PDU session.

At 2122, rules for the requested PDU session are generated (e.g., derived) If the received DNN from the AMF 2102 is configured to support the MPQUIC steering functionality and the connection type, the SMF 2104 derives, from the received PCC rules, (a) ATSSS rules, which will be sent to the UE 104 for controlling the traffic steering, switching and splitting in the uplink direction and (b) N4 rules, which will be sent to the UPF 2108 for controlling the traffic steering, switching and splitting in the downlink direction.

At 2124, the SMF 2104 communicates (e.g., transmits, sends) a session establishment request to the UPF 2108. For example, the SMF 2104 initiates an N4 Session establishment procedure with the UPF 2108 by sending N4 rules derived by the SMF 2104 for the requested MA PDU session to instruct the UPF 2108 to activate the MPQUIC functionality for this MA PDU session. This allows the UPF 2108 to activate the MPQUIC functionality for the requested MA PDU session.

At 2126, the UPF 2108 communicates (e.g., transmits, sends) to the SMF 2104 a response to the session establishment request. For example, the UPF 2108 allocates the UE 104 “MPQUIC link-specific multipath” addresses/prefixes and sends the “MPQUIC link-specific multipath” addresses/prefixes and MPQUIC proxy information to the SMF 2104. This allows the “MPQUIC link-specific multipath” addresses/prefixes and MPQUIC proxy information to be returned to the UE 104.

At 2128, the SMF 2104 communicates (e.g., transmits, sends) to the AMF 2102 an indication that the requested MA PDU session has been accepted. For example, the SMF 2104 includes an “MA PDU session Accepted” indication in the Namf_Communication_NIN2MessageTransfer message to the AMF 2102 and indicates to the AMF that the N2 SM Information included in this message should be sent to the UE 104. The AMF marks this PDU session as MA PDU session based on the received “MA PDU session Accepted” indication. This allows the AMF 2102 to be able to notify the UE 104 that the requested MA PDU session has been accepted by the wireless communications system 100.

At 2130, the AMF 2102 communicates (e.g., transmits, sends) a response message to the UE 104, which is an indication that the requested MA PDU session has been accepted. For example, the UE 104 receives a PDU session establishment accept message, which indicates to UE 104 that the requested MA PDU session was successfully established. This message includes the ATSSS rules for the MA PDU session, which were derived by the SMF 2104 and the “MPQUIC link-specific multipath” addresses/prefixes of the UE 104 and the MPQUIC proxy information. This provides the UE 104 with the information and rules to use to for the UDP flow 2112.

At 2112, the uplink and downlink data are established for the requested MA PDU session. The UE 104 follows the ATSSS rules to establish the UDP flow 2112. According to the ATSSS rules, the UE 104 is to use the MPQUIC steering functionality with the associated connection type which may mean the UPF 2108 can act as proxy for that connection type for the service.

Returning to FIG. 1, with respect to establishing a PDN connection as the user plane resource of an MA PDU session, if the UE 104 establishes a PDN connection as the user plane resource of the MA PDU session, the UE 104 uses the ATSSS request PCO parameter defined in 3GPP TS 24.913 to inform the SMF and PDN gateway control plane function (SMF+PGW-C) about the UE's capability for the steering functionalities. The ATSSS request PCO parameter is listed in the ATSSS request PCO parameter container contents.

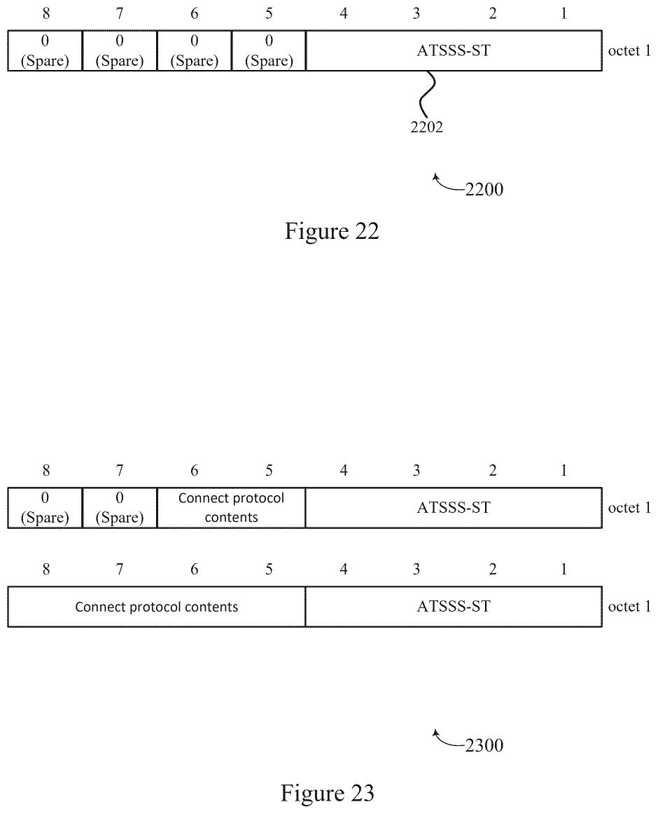

FIG. 22 illustrates an example 2200 of ATSSS request PCO parameter container contents in accordance with aspects of the present disclosure. In the example 2200, the ATSSS-ST 2202 contains 4 bits identifying the supported ATSSS steering functionalities. Bit values of 0001 indicate that ATSSS Low-Layer (ATSSS-LL) functionality with any steering mode allowed for ATSSS-LL is supported. Bit values of 0010 indicate that multipath TCP (MPTCP) functionality with any steering mode and ATSSS-LL functionality with only active-standby steering mode is supported. Bit values of 0011 indicate that MPTCP functionality with any steering mode and ATSSS-LL functionality with any steering mode allowed for ATSSS-LL is supported. Bit values of 0100 indicate that MPQUIC functionality with any steering mode and ATSSS-LL functionality with only active-standby steering mode is supported. Bit values of 0101 indicate that MPQUIC functionality with any steering mode and ATSSS-LL functionality with any steering mode allowed for ATSSS-LL is supported. Bit values of 0110 indicate that MPTCP functionality with any steering mode, MPQUIC functionality with any steering mode and ATSSS-LL functionality with only active-standby steering mode is supported. Bit values of 0111 indicate that MPTCP functionality with any steering mode, MPQUIC functionality with any steering mode and ATSSS-LL functionality with any steering mode allowed for ATSSS-LL is supported.

The UE 104 uses a container with the container identifier “ATSSS request” within the extended protocol configuration options (ePCO) information element (discussed in 3GPP TS 24.008) to transmit the ATSSS request PCO parameter to the SMF+PGW-C. If the UE 104 supports MPQUIC with other proxy protocols than connect-udp and in case of IP-based PDU Session types, the UE 104 includes in the ePCO information element the supported MPQUIC proxy protocols (e.g., connect-ip, connect-udp and/or connect-tcp).

In one or more implementations, the UE 104 inserts the ATSSS request PCO parameter container (used to list the UE's capability for the steering functionalities when establishing an MA PDU session) as the content of a container with container ID of ATSSS request, described in TS 24.008. The container with container ID of ATSSS request is inserted in the ePCO IE of the PDN CONNECTIVITY REQUEST message in TS 24.301 (e.g., 4G) or in the ePCO IE of the PDU SESSION ESTABLISHMENT REQUEST message in TS 24.501 (e.g., 5G) when the UE 104 intends to establish a PDN connection or a PDU session.

FIG. 23 illustrates an example 2300 of ATSSS request PCO parameter container contents in accordance with aspects of the present disclosure. In the example 2300, at least 2 bits of the remaining 4 bits (5 thru 8) of octet 1 of the ATSSS request PCO parameter container are used to indicate the preferred or supported connection type. The top configuration uses 2 bits and the lower configuration uses all 4 bits to identify the supported or preferred connection type for the MPQUIC steering functionality. Therefore, the preferred or supported connection type for the MPQUIC steering functionality of the MA PDU session can be identified as: 0 . . . 00 for connect-UDP, 0 . . . 01 for connect-ip, 0 . . . 10 for connect-ethernet, and 0 . . . 11 for connect-tcp.

For example, if there are 4 bits used to identify the connection type, the connection type can be identified as 0000 for connect-UDP, 0001 for connect-ip, 0010 for connect-ethernet, and 0011 for connect-TCP. By way of another example, if there are 4 bits used to identify the connection type, the connection type can be identified as 0000 for connect-UDP, 0001 for connect-ip, 0010 for connect-ethernet, 0011 for connect-tcp, 0100 for connect-udp and connect-ip, 0101 for connect-udp and connect-ethernet, 0110 for connect-udp and connect-tcp, 0111 for connect-ip and connect-ethernet, 1000 for connect-ip and connect-tcp, 1001 for connect-ethernet and connect-tcp, 0111 for connect-ip and connect-ethernet, 1000 for connect-ip and connect-tcp, 1001 for connect-ethernet and connect-tcp, 1010 for connect-udp, connect-ip, and connect-ethernet, 1011 for connect-udp, connect-ip, and connect-tcp, 1100 for connect-udp, connect-ethernet, and connect-tcp, 1110 for connect-ip, connect-ethernet, and connect-TCP, and 1111 for connect-ip, connect-udp, connect-ethernet, and connect-tcp.

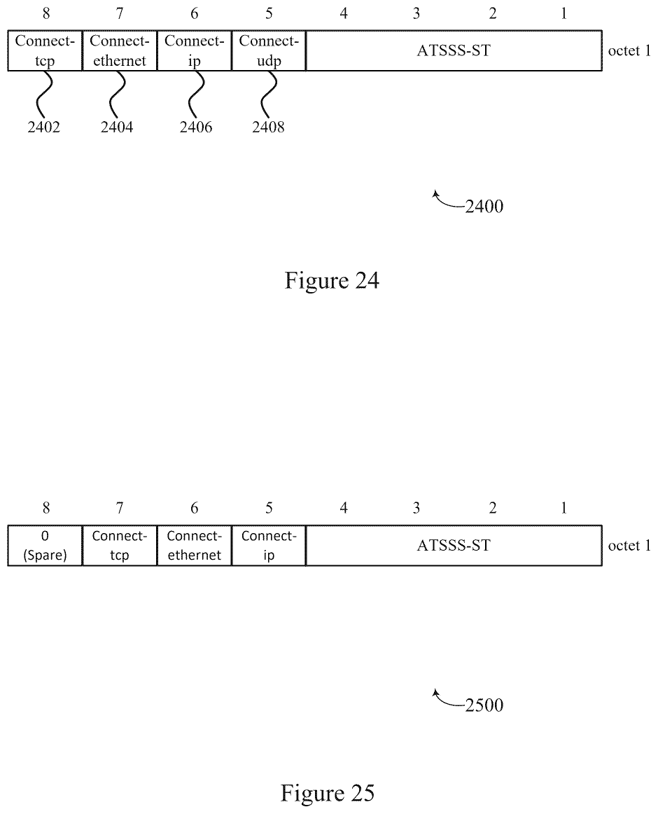

FIG. 24 illustrates an example 2400 of ATSSS request PCO parameter container contents in accordance with aspects of the present disclosure. In the example 2400, the UE 104 is able to list several connection types in the connect protocol contents of the ATSSS request PCO parameter by assigning each bit to represent support for a connection type. The UE 104 lists the supported or preferred connection types by setting that connection type to the value “1”. For example, the connect-tcp bit 2402 is set to the value of “1” if TCP is the supported or preferred connection type, the connect-ethernet bit 2404 is set to the value of “1” if Ethernet is the supported or preferred connection type, the connect-ip bit 2406 is set to the value of “1” if IP is the supported or preferred connection type, and the connect-UDP bit 2408 is set to the value of “1” if UDP is the supported or preferred connection type. If all the bits are set to the value “0”, it means that the supported connection type is connect-udp. Thus, the connect protocol information element is backward compatible with release 18 of ATSSS where the connection type was connect-udp as default.

FIG. 25 illustrates an example 2500 of ATSSS request PCO parameter container contents in accordance with aspects of the present disclosure. The ATSSS request PCO parameter container contents in the example 2500 are similar to the ATSSS request PCO parameter container contents in the example 2400, except that the example 2500 does not include a connect-udp bit. Since in release 18 of 3GPP the ATSSS feature supports connect-udp as the default connection type for MPQUIC steering functionality, it may be assumed that no indication is needed if the connect-udp is preferred (e.g., required) and/or supported by the UE during the MA PDU session. Thus, the connect protocol information element shown in example 2500 contains only the indicator for connect-ip, connect-ethernet, and/or connect-tcp. Thus, if the connect protocol is not included for the procedure of MA PDU session establishment or modification procedures, it is assumed that connect-udp is preferred (e.g., required) or supported by the UE for the MPQUIC steering functionality. When using the connect protocol information element of example 2500, it is assumed that the UE supports connect-udp by default if the UE wants to list more than one connection type.

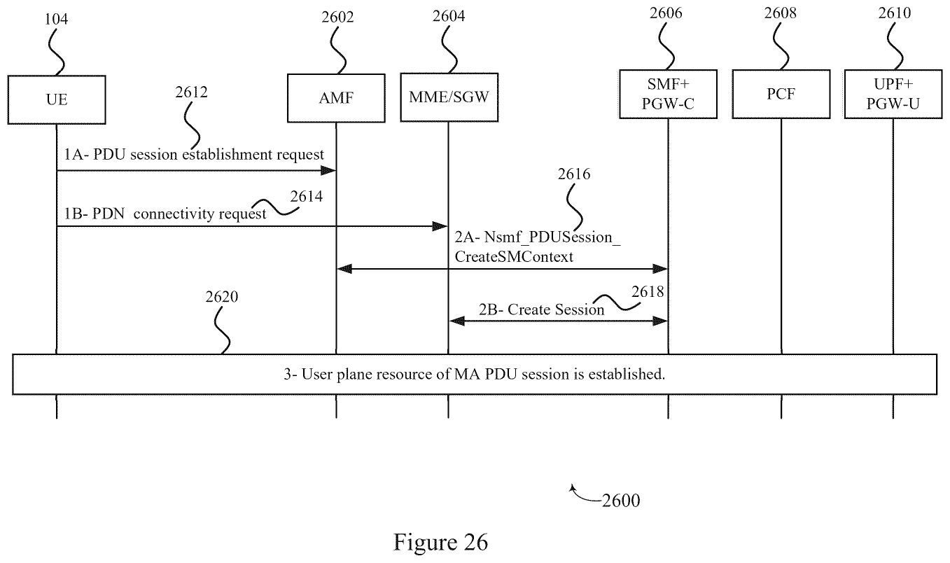

FIG. 26 illustrates an example 2600 of MA PDU session establishment in accordance with aspects of the present disclosure. FIG. 26 illustrates that the UE 104 can send the ATSSS PCO parameter using the extended protocol configuration options information element by using the PDU session establishment procedure defined in 3GPP TS 24.501 or PDN connectivity procedure defined in 3GPP TS 24.301.

The example 2600 illustrates a UE 104, an AMF 2602, a MME/SGW 2604, a SMF+PGW-C 2606, a PCF 2608, and a UPF and PDN gateway user plane function (UPF+PGW-U) 2610, and a user plane function (UPF) 2108. The AMF, MME/SGW, SMF+PGW-C, PCF, and UPF+PGW-U are functions implemented by the wireless communications system 100, such as in the CN 106. The UE 104 communicates (e.g., transmits, sends) data, information, requests, etc. to a NE 102 (e.g., a base station), which communicates (e.g., transmits, sends) the data, information, requests, etc. to the appropriate function in the CN 106. Similarly, a function in the CN 106 communicates (e.g., transmits, sends) data, information, requests, etc. to a NE 102 (e.g., a base station), which communicates (e.g., transmits, sends) the data, information, requests, etc. to the UE 104.

At 2612, the UE 104 initiates (e.g., communicates, transmits, sends) a request message (e.g., a NAS message) to the AMF 2602. The request message is, for example, a PDU session establishment request. The UE 104 initiates the UE-requested MA PDU session establishment procedure by including several information elements within the NAS message for establishing the resource of the MA PDU session establishment procedure including those which are used for the MA PDU session within the extended protocol configuration options information header. Connect protocol information can be included in the request message using any of the ATSSS request PCO parameter container contents discussed above. The session establishment request at 2612 notifies the CN 106 (e.g., the AMF 2602) of the UE's desire to establish a MA PDU session.

At 2614, the UE transmits a connectivity request message to the MME/SGW. The connectivity request message is, for example, a PDN connectivity request message. The UE 104 initiates the PDN connectivity procedure by including several information elements within the NAS message for establishing the resource of the MA PDU session including those which are needed for such a resource and within the extended protocol configuration options information header.

At 2616, the AMF 2602 determines an SMF based on the session establishment request received from the UE 104. Upon determining the SMF (which is part of the SMF+PGW-C), the AMF 2602 constructs and communicates (e.g., transmits, sends) to the SMF a request to generate an SM context. The request to generate the SM context is, for example, an Nsmf_PDUSession_CreateSMContext request with information elements to create an SM context. The request to generate the SM context provides the SMF 2104 the appropriate data, information, etc. to establish a SM context for the requested MA PDU session.

At 2618, the requested session is created. Upon determining the SGW and SMF+PGW-C, the MME (which is part of the MME/SGW 2604) initiates (e.g., communicates, transmits, sends) a request to the SMF+PGW-C to create the requested session. The MME/SGW 2604 communicates with the SMF+PGW-C 2606 to create the requested session. This allows the requested user plane resource of MA PDU session to be established.

At 2620, if the received DNN from the AMF 2602 or MME (which is part of the MME/SGW), is configured to support the MPQUIC steering functionality and the connection type, from the received PCC rules, the SMF derives (a) ATSSS rules, which will be sent to the UE 104 for controlling the traffic steering, switching and splitting in the uplink direction and (b) N4 rules, which will be sent to the UPF+PGW-U 2610 for controlling the traffic steering, switching and splitting in the downlink direction. The resource is now allocated for the requested MA PDU session.

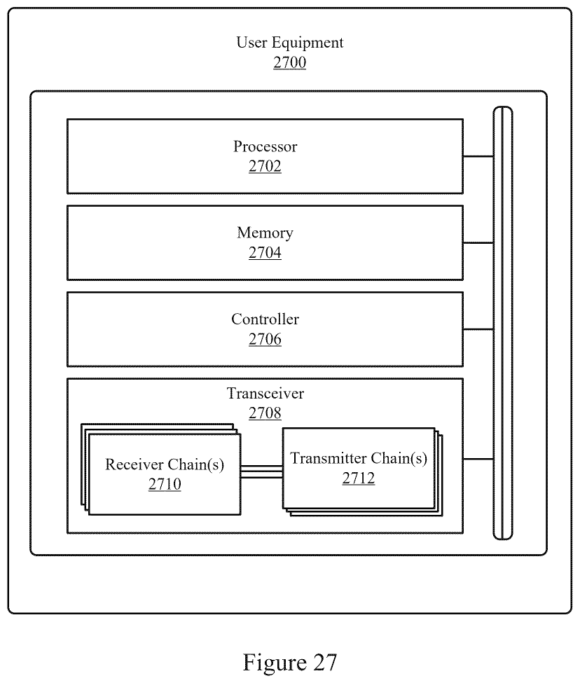

FIG. 27 illustrates an example of a UE 2700 in accordance with aspects of the present disclosure. The UE 2700 may include a processor 2702, a memory 2704, a controller 2706, and a transceiver 2708. The processor 2702, the memory 2704, the controller 2706, or the transceiver 2708, or various combinations thereof or various components thereof may be examples of means for performing various aspects of the present disclosure as described herein. These components may be coupled (e.g., operatively, communicatively, functionally, electronically, electrically) via one or more interfaces.

The processor 2702, the memory 2704, the controller 2706, or the transceiver 2708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2702 may include an intelligent hardware device (e.g., a general-purpose processor, a DSP, a CPU, an ASIC, an FPGA, or any combination thereof). In some implementations, the processor 2702 may be configured to operate the memory 2704. In some other implementations, the memory 2704 may be integrated into the processor 2702. The processor 2702 may be configured to execute computer-readable instructions stored in the memory 2704 to cause the UE 2700 to perform various functions of the present disclosure.

The memory 2704 may include volatile or non-volatile memory. The memory 2704 may store computer-readable, computer-executable code including instructions when executed by the processor 2702 cause the UE 2700 to perform various functions described herein. The code may be stored in a non-transitory computer-readable medium such as the memory 2704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2702 and the memory 2704 coupled with the processor 2702 may be configured to cause the UE 2700 to perform one or more of the functions described herein (e.g., executing, by the processor 2702, instructions stored in the memory 2704). For example, the processor 2702 may support wireless communication at the UE 2700 in accordance with examples as disclosed herein. The UE 2700 may be configured to or operable to support a means for transmitting a request message to establish a PDU session or a PDN connection, where the request message includes an indication of a connect protocol for the PDU session or the PDN connection, where the indication is included in at least one of a standalone information element or a part of the information element; and receiving a response message based at least in part on the request message, where the response includes one or more rules for the PDU session or the PDN connection.

Additionally, the UE 2700 may be configured to support any one or combination of where the connect protocol comprises: a UDP, an IP, an ethernet protocol, or a TCP; where the part of the information element comprises a capability information element, and where the capability information element comprises a 5GSM capability information element; where the part of the information element comprises an ATSSS request PCO parameter container within an additional container, where the additional container is identified as an ATSSS request and is included within an ePCO information element; where the indication comprises at least one bit, and where a value of the at least one bit is indicative of whether the connect protocol is supported or preferred by the UE; where a first value of the at least one bit is indicative of the connect protocol supported or preferred by the UE, and where a second value of the at least one bit is indicative of the connect protocol not supported or not preferred by the UE; where the connect protocol comprises a UDP in response to no bit of the at least one bit indicating a connect protocol supported or preferred by the UE; where the request message includes a DNN or an APN, and where the connect protocol and at least one of the DNN or the APN are input for a steering functionality associated with MPQUIC; where at least one user plane resource of a MA-PDU session is established based at least in part on the PDU session or the PDN connection.

Additionally, or alternatively, the UE 2700 may support at least one memory (e.g., the memory 2704) and at least one processor (e.g., the processor 2702) coupled with the at least one memory and configured to cause the UE to: transmit a request message to establish a PDU session or a PDN connection, where the request message includes an indication of a connect protocol for the PDU session or the PDN connection, where the indication is included in at least one of a standalone information element or a part of an information element; and receive a response message based at least in part on the request message, where the response includes one or more rules for the PDU session or the PDN connection.

Additionally, the UE 2700 may be configured to support any one or combination of where the connect protocol comprises: a UDP, an IP, an ethernet protocol, or a TCP; where the part of the information element comprises a capability information element, and where the capability information element comprises a 5GSM capability information element; where the part of the information element comprises an ATSSS request PCO parameter container within an additional container, where the additional container is identified as an ATSSS request and is included within an ePCO information element; where the indication comprises at least one bit, and where a value of the at least one bit is indicative of whether the connect protocol is supported or preferred by the UE; where a first value of the at least one bit is indicative of the connect protocol supported or preferred by the UE, and where a second value of the at least one bit is indicative of the connect protocol not supported or not preferred by the UE; where the connect protocol comprises a UDP in response to no bit of the at least one bit indicating a connect protocol supported or preferred by the UE; where the request message includes a DNN or an APN, and where the connect protocol and at least one of the DNN or the APN are input for a steering functionality associated with MPQUIC; where at least one user plane resource of a MA-PDU session is established based at least in part on the PDU session or the PDN connection.

The controller 2706 may manage input and output signals for the UE 2700. The controller 2706 may also manage peripherals not integrated into the UE 2700. In some implementations, the controller 2706 may utilize an operating system such as iOS®, ANDROID®, WINDOWS®, or other operating systems. In some implementations, the controller 2706 may be implemented as part of the processor 2702.

In some implementations, the UE 2700 may include at least one transceiver 2708. In some other implementations, the UE 2700 may have more than one transceiver 2708. The transceiver 2708 may represent a wireless transceiver. The transceiver 2708 may include one or more receiver chains 2710, one or more transmitter chains 2712, or a combination thereof.

A receiver chain 2710 may be configured to receive signals (e.g., control information, data, packets) over a wireless medium. For example, the receiver chain 2710 may include one or more antennas to receive a signal over the air or wireless medium. The receiver chain 2710 may include at least one amplifier (e.g., a low-noise amplifier (LNA)) configured to amplify the received signal. The receiver chain 2710 may include at least one demodulator configured to demodulate the receive signal and obtain the transmitted data by reversing the modulation technique applied during transmission of the signal. The receiver chain 2710 may include at least one decoder for decoding the demodulated signal to receive the transmitted data.

A transmitter chain 2712 may be configured to generate and transmit signals (e.g., control information, data, packets). The transmitter chain 2712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2712 may also include at least one power amplifier configured to amplify the modulated signal to an appropriate power level suitable for transmission over the wireless medium. The transmitter chain 2712 may also include one or more antennas for transmitting the amplified signal into the air or wireless medium.

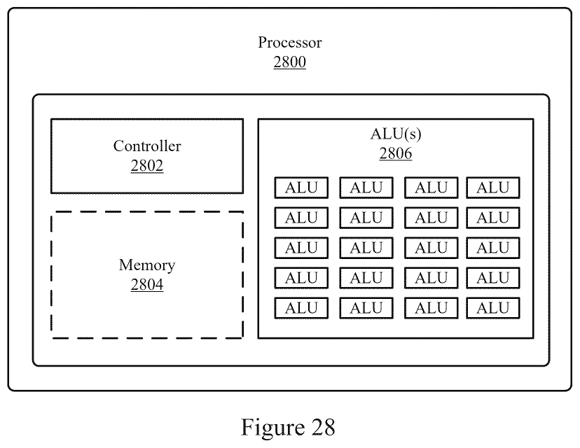

FIG. 28 illustrates an example of a processor 2800 in accordance with aspects of the present disclosure. The processor 2800 may be an example of a processor configured to perform various operations in accordance with examples as described herein. The processor 2800 may include a controller 2802 configured to perform various operations in accordance with examples as described herein. The processor 2800 may optionally include at least one memory 2804, which may be, for example, an L1/L2/L3 cache. Additionally, or alternatively, the processor 2800 may optionally include one or more arithmetic-logic units (ALUs) 2806. One or more of these components may be in electronic communication or otherwise coupled (e.g., operatively, communicatively, functionally, electronically, electrically) via one or more interfaces (e.g., buses).

The processor 2800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2802 may be configured to manage and coordinate various operations (e.g., signaling, receiving, obtaining, retrieving, transmitting, outputting, forwarding, storing, determining, identifying, accessing, writing, reading) of the processor 2800 to cause the processor 2800 to support various operations in accordance with examples as described herein. For example, the controller 2802 may operate as a control unit of the processor 2800, generating control signals that manage the operation of various components of the processor 2800. These control signals include enabling or disabling functional units, selecting data paths, initiating memory access, and coordinating timing of operations.

The controller 2802 may be configured to fetch (e.g., obtain, retrieve, receive) instructions from the memory 2804 and determine subsequent instruction(s) to be executed to cause the processor 2800 to support various operations in accordance with examples as described herein. The controller 2802 may be configured to track memory addresses of instructions associated with the memory 2804. The controller 2802 may be configured to decode instructions to determine the operation to be performed and the operands involved. For example, the controller 2802 may be configured to interpret the instruction and determine control signals to be output to other components of the processor 2800 to cause the processor 2800 to support various operations in accordance with examples as described herein. Additionally, or alternatively, the controller 2802 may be configured to manage flow of data within the processor 2800. The controller 2802 may be configured to control transfer of data between registers, ALUs 2806, and other functional units of the processor 2800.

The memory 2804 may include one or more caches (e.g., memory local to or included in the processor 2800 or other memory, such as RAM, ROM, DRAM, SDRAM, SRAM, MRAM, flash memory, etc. In some implementations, the memory 2804 may reside within or on a processor chipset (e.g., local to the processor 2800). In some other implementations, the memory 2804 may reside external to the processor chipset (e.g., remote to the processor 2800).

The memory 2804 may store computer-readable, computer-executable code including instructions that, when executed by the processor 2800, cause the processor 2800 to perform various functions described herein. The code may be stored in a non-transitory computer-readable medium such as system memory or another type of memory. The controller 2802 and/or the processor 2800 may be configured to execute computer-readable instructions stored in the memory 2804 to cause the processor 2800 to perform various functions. For example, the processor 2800 and/or the controller 2802 may be coupled with or to the memory 2804, the processor 2800, and the controller 2802, and may be configured to perform various functions described herein. In some examples, the processor 2800 may include multiple processors and the memory 2804 may include multiple memories. One or more of the multiple processors may be coupled with one or more of the multiple memories, which may, individually or collectively, be configured to perform various functions herein.

The one or more ALUs 2806 may be configured to support various operations in accordance with examples as described herein. In some implementations, the one or more ALUs 2806 may reside within or on a processor chipset (e.g., the processor 2800). In some other implementations, the one or more ALUs 2806 may reside external to the processor chipset (e.g., the processor 2800). One or more ALUs 2806 may perform one or more computations such as addition, subtraction, multiplication, and division on data. For example, one or more ALUs 2806 may receive input operands and an operation code, which determines an operation to be executed. One or more ALUs 2806 may be configured with a variety of logical and arithmetic circuits, including adders, subtractors, shifters, and logic gates, to process and manipulate the data according to the operation. Additionally, or alternatively, the one or more ALUs 2806 may support logical operations such as AND, OR, exclusive-OR (XOR), not-OR (NOR), and not-AND (NAND), enabling the one or more ALUs 2806 to handle conditional operations, comparisons, and bitwise operations.

The processor 2800 may support wireless communication in accordance with examples as disclosed herein. The processor 2800 may be configured to or operable to support at least one controller (e.g., the controller 2802) coupled with at least one memory (e.g., the memory 2804) and configured to cause the processor to: transmit a request message to establish a PDU session or a PDN connection, where the request message includes an indication of a connect protocol for the PDU session or the PDN connection, where the indication is included in at least one of a standalone information element or a part of an information element; and receive a response message based at least in part on the request message, where the response includes one or more rules for the PDU session or the PDN connection.

Additionally, the processor 2800 may be configured to or operable to support any one or combination of where the connect protocol comprises: a UDP, an IP, an ethernet protocol, or a TCP; where the part of the information element comprises a capability information element, and where the capability information element comprises a 5GSM capability information element; where the part of the information element comprises an ATSSS request PCO parameter container within an additional container, where the additional container is identified as an ATSSS request and is included within an ePCO information element; where the indication comprises at least one bit, and where a value of the at least one bit is indicative of whether the connect protocol is supported or preferred by the processor; where a first value of the at least one bit is indicative of the connect protocol supported or preferred by the processor, and where a second value of the at least one bit is indicative of the connect protocol not supported or not preferred by the processor; where the request message includes a data DNN or an APN, and where the connect protocol and at least one of the DNN or the APN are input for a steering functionality associated with MPQUIC; where the connect protocol comprises a UDP in response to no bit of the at least one bit indicating a connect protocol supported or preferred by the processor; where at least one user plane resource of a MA-PDU session is established based at least in part on the PDU session or the PDN connection.

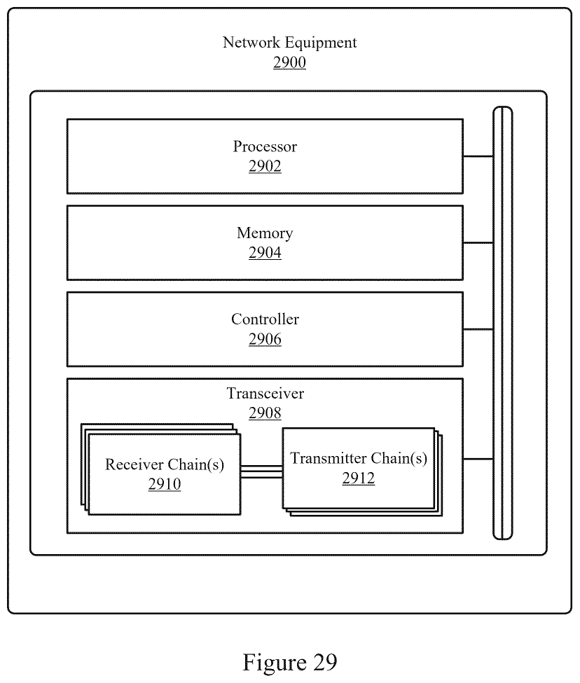

FIG. 29 illustrates an example of a NE 2900 in accordance with aspects of the present disclosure. The NE 2900 may include a processor 2902, a memory 2904, a controller 2906, and a transceiver 2908. The processor 2902, the memory 2904, the controller 2906, or the transceiver 2908, or various combinations thereof or various components thereof may be examples of means for performing various aspects of the present disclosure as described herein. These components may be coupled (e.g., operatively, communicatively, functionally, electronically, electrically) via one or more interfaces.

The processor 2902, the memory 2904, the controller 2906, or the transceiver 2908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2902 may include an intelligent hardware device (e.g., a general-purpose processor, a DSP, a CPU, an ASIC, an FPGA, or any combination thereof). In some implementations, the processor 2902 may be configured to operate the memory 2904. In some other implementations, the memory 2904 may be integrated into the processor 2902. The processor 2902 may be configured to execute computer-readable instructions stored in the memory 2904 to cause the NE 2900 to perform various functions of the present disclosure.

The memory 2904 may include volatile or non-volatile memory. The memory 2904 may store computer-readable, computer-executable code including instructions when executed by the processor 2902 cause the NE 2900 to perform various functions described herein. The code may be stored in a non-transitory computer-readable medium such as the memory 2904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2902 and the memory 2904 coupled with the processor 2902 may be configured to cause the NE 2900 to perform one or more of the functions described herein (e.g., executing, by the processor 2902, instructions stored in the memory 2904). For example, the processor 2902 may support wireless communication at the NE 2900 in accordance with examples as disclosed herein. The NE 2900 may be configured to support a means for receiving, a request message to establish a PDU session or a PDN connection, where the request message includes an indication of a connect protocol for the PDU session or the PDN connection, where the indication is included in at least one of a standalone information element or a part of an information element; and transmitting a response message based at least in part on the request message, where the response includes one or more rules for the PDU session or the PDN connection.

Additionally, the NE 2900 may be configured to support any one or combination of where the connect protocol comprises: a UDP, an IP, an ethernet protocol, or a TCP; where the part of the information element comprises a capability information element, and where the capability information element comprises a 5GSM capability information element; where the part of the information element comprises an ATSSS request PCO parameter container within an additional container, where the additional container is identified as an ATSSS request and is included within an ePCO information element; where the indication comprises at least one bit, and where a value of the at least one bit is indicative of whether the connect protocol is supported or preferred by a UE; where a first value of the at least one bit is indicative of the connect protocol supported or preferred by the UE, and where a second value of the at least one bit is indicative of the connect protocol not supported or not preferred by the UE; where the connect protocol comprises a UDP in response to no bit of the at least one bit indicating a connect protocol supported or preferred by a UE; the request message includes a data DNN or an APN, and where the connect protocol and at least one of the DNN or the APN are input for a steering functionality associated with MPQUIC, and checking whether the DNN or APN can comply with the indicated connect protocol; and transmitting the response message including the one or more rules in response to the DNN or APN being able to comply with the indicated connect protocol; where at least one user plane resource of a MA-PDU session is established based at least in part on the PDU session or the PDN connection.

Additionally, or alternatively, the NE 2900 may support at least one memory (e.g., the memory 2904) and at least one processor (e.g., the processor 2902) coupled with the at least one memory and configured to cause the NE to: receive, a request message to establish a PDU session or a PDN connection, where the request message includes an indication of a connect protocol for the PDU session or the PDN connection, where the indication is included in at least one of a standalone information element or a part of an information element; and transmit a response message based at least in part on the request message, where the response includes one or more rules for the PDU session or the PDN connection.

Additionally, the NE 2900 may be configured to support any one or combination of where the connect protocol comprises: a UDP, an IP, an ethernet protocol, or a TCP; where the part of the information element comprises a capability information element, and where the capability information element comprises a 5GSM capability information element; where the part of the information element comprises an ATSSS request PCO parameter container within an additional container, where the additional container is identified as an ATSSS request and is included within an ePCO information element; where the indication comprises at least one bit, and where a value of the at least one bit is indicative of whether the connect protocol is supported or preferred by a UE; where a first value of the at least one bit is indicative of the connect protocol supported or preferred by the UE, and where a second value of the at least one bit is indicative of the connect protocol not supported or not preferred by the UE; where the connect protocol comprises a UDP in response to no bit of the at least one bit indicating a connect protocol supported or preferred by a UE; where the request message includes a data DNN or an APN, and where the connect protocol and at least one of the DNN or the APN are input for a steering functionality associated with MPQUIC, and the at least one processor is further configured to cause the NE to: check whether the DNN or APN can comply with the indicated connect protocol; and transmit the response message including the one or more rules in response to the DNN or APN being able to comply with the indicated connect protocol; where at least one user plane resource of a MA-PDU session is established based at least in part on the PDU session or the PDN connection.

The controller 2906 may manage input and output signals for the NE 2900. The controller 2906 may also manage peripherals not integrated into the NE 2900. In some implementations, the controller 2906 may utilize an operating system such as iOS®, ANDROID®, WINDOWS®, or other operating systems. In some implementations, the controller 2906 may be implemented as part of the processor 2902.

In some implementations, the NE 2900 may include at least one transceiver 2908. In some other implementations, the NE 2900 may have more than one transceiver 2908. The transceiver 2908 may represent a wireless transceiver. The transceiver 2908 may include one or more receiver chains 2910, one or more transmitter chains 2912, or a combination thereof.

A receiver chain 2910 may be configured to receive signals (e.g., control information, data, packets) over a wireless medium. For example, the receiver chain 2910 may include one or more antennas to receive a signal over the air or wireless medium. The receiver chain 2910 may include at least one amplifier (e.g., a low-noise amplifier (LNA)) configured to amplify the received signal. The receiver chain 2910 may include at least one demodulator configured to demodulate the receive signal and obtain the transmitted data by reversing the modulation technique applied during transmission of the signal. The receiver chain 2910 may include at least one decoder for decoding the demodulated signal to receive the transmitted data.

A transmitter chain 2912 may be configured to generate and transmit signals (e.g., control information, data, packets). The transmitter chain 2912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 2912 may also include at least one power amplifier configured to amplify the modulated signal to an appropriate power level suitable for transmission over the wireless medium. The transmitter chain 2912 may also include one or more antennas for transmitting the amplified signal into the air or wireless medium.

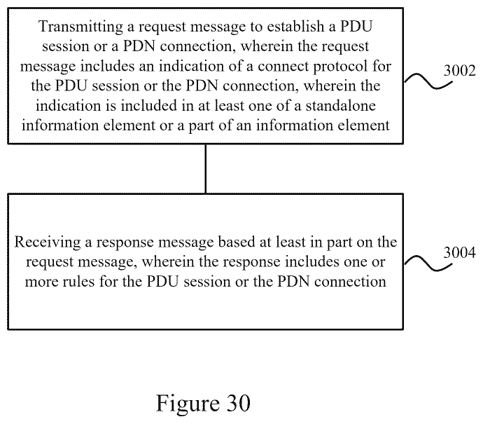

FIG. 30 illustrates a flowchart of a method in accordance with aspects of the present disclosure. The operations of the method may be implemented by a UE as described herein. In some implementations, the UE may execute a set of instructions to control the function elements of the UE to perform the described functions.

At 3002, the method may include transmitting a request message to establish a PDU session or a PDN connection, wherein the request message includes an indication of a connect protocol for the PDU session or the PDN connection, wherein the indication is included in at least one of a standalone information element or a part of an information element. The operations of 3002 may be performed in accordance with examples as described herein. In some implementations, aspects of the operations of 3002 may be performed by a UE as described with reference to FIG. 27.

At 3004, the method may include receiving a response message based at least in part on the request message, wherein the response includes one or more rules for the PDU session or the PDN connection. The operations of 3004 may be performed in accordance with examples as described herein. In some implementations, aspects of the operations of 3004 may be performed by a UE as described with reference to FIG. 27.

It should be noted that the method described herein describes a possible implementation, and that the operations and the steps may be rearranged or otherwise modified and that other implementations are possible.

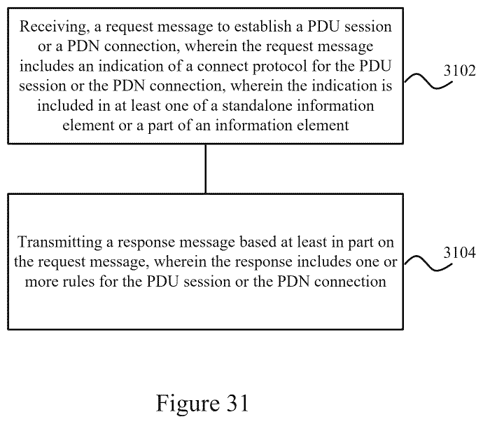

FIG. 31 illustrates a flowchart of a method in accordance with aspects of the present disclosure. The operations of the method may be implemented by a NE as described herein. In some implementations, the NE may execute a set of instructions to control the function elements of the NE to perform the described functions.

At 3102, the method may include receiving, a request message to establish a PDU session or a PDN connection, wherein the request message includes an indication of a connect protocol for the PDU session or the PDN connection, wherein the indication is included in at least one of a standalone information element or a part of an information element. The operations of 3102 may be performed in accordance with examples as described herein. In some implementations, aspects of the operations of 3102 may be performed by a NE as described with reference to FIG. 29.

At 3104, the method may include transmitting a response message based at least in part on the request message, wherein the response includes one or more rules for the PDU session or the PDN connection. The operations of 3104 may be performed in accordance with examples as described herein. In some implementations, aspects of the operations of 3104 may be performed by a NE as described with reference to FIG. 29.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
transmit a request message to establish a protocol data unit (PDU) session or a packet data network (PDN) connection, wherein the request message includes an indication of a connect protocol for the PDU session or the PDN connection, wherein the indication is included in at least one of a standalone information element or a part of an information element; and
receive a response message based at least in part on the request message, wherein the response includes one or more rules for the PDU session or the PDN connection.

2. The UE of claim 1, wherein the connect protocol comprises: a user datagram protocol (UDP), an Internet protocol (IP), an ethernet protocol, or a transmission control protocol (TCP).

3. The UE of claim 1, wherein the part of the information element comprises a capability information element, and wherein the capability information element comprises a fifth generation (5G) session management (5GSM) capability information element.

4. The UE of claim 1, wherein the part of the information element comprises an access traffic steering, switching, splitting (ATSSS) request protocol configuration options (PCO) parameter container within an additional container, wherein the additional container is identified as an ATSSS request and is included within an extended PCO (ePCO) information element.

5. The UE of claim 1, wherein the indication comprises at least one bit, and wherein a value of the at least one bit is indicative of whether the connect protocol is supported or preferred by the UE.

6. The UE of claim 5, wherein a first value of the at least one bit is indicative of the connect protocol supported or preferred by the UE, and wherein a second value of the at least one bit is indicative of the connect protocol not supported or not preferred by the UE.

7. The UE of claim 5, wherein the connect protocol comprises a user datagram protocol (UDP) in response to no bit of the at least one bit indicating a connect protocol supported or preferred by the UE.

8. The UE of claim 1, wherein the request message includes a data network name (DNN) or an access point name (APN), and wherein the connect protocol and at least one of the DNN or the APN are input for a steering functionality associated with multipath QUIC (MPQUIC).

9. The UE of claim 1, wherein at least one user plane resource of a multiple access PDU (MA-PDU) session is established based at least in part on the PDU session or the PDN connection.

10. A processor for wireless communication, comprising:
at least one controller coupled with at least one memory and configured to cause the processor to:
transmit a request message to establish a protocol data unit (PDU) session or a packet data network (PDN) connection, wherein the request message includes an indication of a connect protocol for the PDU session or the PDN connection, wherein the indication is included in at least one of a standalone information element or a part of an information element; and
receive a response message based at least in part on the request message, wherein the response includes one or more rules for the PDU session or the PDN connection.

11. The processor of claim 10, wherein the connect protocol comprises: a user datagram protocol (UDP), an Internet protocol (IP), an ethernet protocol, or a transmission control protocol (TCP).

12. The processor of claim 10, wherein the part of the information element comprises a capability information element, and wherein the capability information element comprises a fifth generation (5G) session management (5GSM) capability information element.

13. The processor of claim 10, wherein the part of the information element comprises an access traffic steering, switching, splitting (ATSSS) request protocol configuration options (PCO) parameter container within an additional container, wherein the additional container is identified as an ATSSS request and is included within an extended PCO (ePCO) information element.

14. The processor of claim 10, wherein the indication comprises at least one bit, and wherein a value of the at least one bit is indicative of whether the connect protocol is supported or preferred by the processor.

15. The processor of claim 14, wherein a first value of the at least one bit is indicative of the connect protocol supported or preferred by the processor, and wherein a second value of the at least one bit is indicative of the connect protocol not supported or not preferred by the processor.

16. The processor of claim 10, wherein the request message includes a data network name (DNN) or an access point name (APN), and wherein the connect protocol and at least one of the DNN or the APN are input for a steering functionality associated with multipath QUIC (MPQUIC).

17. A network equipment for wireless communication, comprising:
at least one memory; and
at least one processor coupled with the at least one memory and configured to cause the network equipment to:
receive, a request message to establish a protocol data unit (PDU) session or a packet data network (PDN) connection, wherein the request message includes an indication of a connect protocol for the PDU session or the PDN connection, wherein the indication is included in at least one of a standalone information element or a part of an information element; and
transmit a response message based at least in part on the request message, wherein the response includes one or more rules for the PDU session or the PDN connection.

18. The network equipment of claim 17, wherein the connect protocol comprises: a user datagram protocol (UDP), an Internet protocol (IP), an ethernet protocol, or a transmission control protocol (TCP).

19. The network equipment of claim 17, wherein the request message includes a data network name (DNN) or an access point name (APN), and wherein the connect protocol and at least one of the DNN or the APN are input for a steering functionality associated with multipath QUIC (MPQUIC), and the at least one processor is further configured to cause the network equipment to:
check whether the DNN or APN can comply with the indicated connect protocol; and
transmit the response message including the one or more rules in response to the DNN or APN being able to comply with the indicated connect protocol.

20. A method performed by a user equipment (UE), the method comprising:
transmitting a request message to establish a protocol data unit (PDU) session or a packet data network (PDN) connection, wherein the request message includes an indication of a connect protocol for the PDU session or the PDN connection, wherein the indication is included in at least one of a standalone information element or a part of the information element; and
receiving a response message based at least in part on the request message, wherein the response includes one or more rules for the PDU session or the PDN connection.
